(19) United States
(12) Patent Application Publication
(10) Pub. No.: US 2015/0242083 A1
(43) Pub. Date: Aug. 27, 2015

(54) CIRCUMFERENTIAL SPAN REGION OF A VIRTUAL SCREEN

(71) Applicant: Nokia Corporation, Espoo (FI)

(72) Inventor: Roope Aleksi Rainisto, Helsinki (FI)

(21) Appl. No.: 14/192,826

(22) Filed: Feb. 27, 2014

(51) Int. Cl. G06F 3/0485; G06F 3/0481; G06F 3/0488; G06F 1/16

(52) U.S. Cl. CPC G06F 3/0485; G06F 1/163; G06F 3/04817; G06F 3/0488; G06F 2203/04102

(57) ABSTRACT

A method comprising identifying a longitudinal edge and an opposite longitudinal edge of a flexible display that is flexed such that the flexible display is in a partial cylindrical configuration, determining a circumferential span from the longitudinal edge to the opposite longitudinal edge, determining circumferential span region of a virtual screen based, at least in part, on the circumferential span, receiving information indicative of an inertial scroll input, determining an inertial scroll stop position based, at least in part, on the inertial scroll input, determining that the inertial scroll stop position corresponds with, at least a portion of, predetermined contiguous content being within the circumferential span region of the virtual screen, and determining an adjusted inertial scroll stop position such that the entirety of the predetermined contiguous content is within a display region of the virtual screen is disclosed.

### TECHNICAL FIELD

The present application relates generally to a circumferential span region of a virtual screen.

### BACKGROUND

Over the years, electronic apparatuses have become increasingly prevalent in our society. As a result, many users of electronic apparatuses have become increasingly reliant upon their electronic apparatuses for purposes relating to communication, scheduling, etc. As such, it may be desirable to configure an electronic apparatus such that a user of the electronic apparatus may interact with the electronic apparatus in an intuitive manner.

### SUMMARY

Various aspects of examples of the invention are set out in the claims.

One or more embodiments may provide an apparatus, a computer readable medium, a non-transitory computer readable medium, a computer program product, and/or a method for identifying a longitudinal edge and an opposite longitudinal edge of a flexible display that is flexed such that the flexible display is in a partial cylindrical configuration, determining a circumferential span from the longitudinal edge to the opposite longitudinal edge, determining circumferential span region of a virtual screen based, at least in part, on the circumferential span, receiving information indicative of an inertial scroll input, determining an inertial scroll stop position based, at least in part, on the inertial scroll input, determining that the inertial scroll stop position corresponds with, at least a portion of, predetermined contiguous content being within the circumferential span region of the virtual screen, and determining an adjusted inertial scroll stop position such that the entirety of the predetermined contiguous content is within a display region of the virtual screen.

One or more embodiments may provide an apparatus, a computer readable medium, a computer program product, and/or a non-transitory computer readable medium having means for identifying a longitudinal edge and an opposite longitudinal edge of a flexible display that is flexed such that the flexible display is in a partial cylindrical configuration, means for determining a circumferential span from the longitudinal edge to the opposite longitudinal edge, means for determining circumferential span region of a virtual screen based, at least in part, on the circumferential span, means for receiving information indicative of an inertial scroll input, means for determining an inertial scroll stop position based, at least in part, on the inertial scroll input, means for determining that the inertial scroll stop position corresponds with, at least a portion of, predetermined contiguous content being within the circumferential span region of the virtual screen, and means for determining an adjusted inertial scroll stop position such that the entirety of the predetermined contiguous content is within a display region of the virtual screen.

One or more embodiments may provide an apparatus, a computer readable medium, a non-transitory computer readable medium, a computer program product, and/or a method for determining that a flexible display is configured such that the flexible display is in a flat configuration, initiating a non-wrapping interaction mode based, at least in part, on the flat configuration, determining that the flexible display has been reconfigured such that the flexible display is in a partial cylindrical configuration, and initiating a wrapping interaction mode based, at least in part, on the partial cylindrical configuration.

One or more embodiments may provide an apparatus, a computer readable medium, a computer program product, and/or a non-transitory computer readable medium having means for determining that a flexible display is configured such that the flexible display is in a flat configuration, means for initiating a non-wrapping interaction mode based, at least in part, on the flat configuration, means for determining that the flexible display has been reconfigured such that the flexible display is in a partial cylindrical configuration, and means for initiating a wrapping interaction mode based, at least in part, on the partial cylindrical configuration.

One or more example embodiments further perform causation of display of the display region of the virtual screen on the flexible display.

One or more example embodiments further perform determination of a different circumferential span from the longitudinal edge to the opposite longitudinal edge, and determination of a different circumferential span region of the virtual screen based, at least in part, on the different circumferential span.

One or more example embodiments further perform resizing of the virtual screen based, at least in part, on the circumferential span region and the different circumferential span region.

One or more example embodiments further perform determination that the flexible display has been reconfigured such that the flexible display is in a different partial cylindrical configuration, wherein the determination of the different circumferential span from the longitudinal edge to the opposite longitudinal edge is based, at least in part, on the determination that the flexible display has been reconfigured such that the flexible display is in the different partial cylindrical configuration.

In at least one example embodiment, the predetermined contiguous content is content that is designated to be displayed in a contiguous manner.

In at least one example embodiment, the contiguous manner refers to display of the predetermined contiguous content avoiding a boundary of the display region intersecting with the predetermined contiguous content.

In at least one example embodiment, the longitudinal edge is an edge of the flexible display that is perpendicular to a circumference of the flexible display in the partial cylindrical configuration.

In at least one example embodiment, the longitudinal edge is an edge of the flexible display that is perpendicular to a circumferential edge of the flexible display in the partial cylindrical configuration.

In at least one example embodiment, the longitudinal edge is substantially parallel to the opposite longitudinal edge.

In at least one example embodiment, in the partial cylindrical configuration, the longitudinal edge and the opposite longitudinal edge are oriented such that the longitudinal edge faces towards the opposite longitudinal edge.

In at least one example embodiment, the identification of the longitudinal edge and the opposite longitudinal edge comprises retrieval of information indicative of the longitudinal edge and the opposite longitudinal edge.

In at least one example embodiment, the identification of the longitudinal edge and the opposite longitudinal edge is based, at least in part, on the partial cylindrical configuration of the flexible display.

One or more example embodiments further perform determination that the flexible display is in a partial cylindrical configuration.

In at least one example embodiment, the flexible display is a display that is configured to flex in at least one dimension.

In at least one example embodiment, the virtual screen comprises the display region of the virtual screen and the circumferential span region of the virtual screen.

In at least one example embodiment, the display region of the virtual screen is distinct from the circumferential span region of the virtual screen.

In at least one example embodiment, the display region of the virtual screen fails to overlap the circumferential span region of the virtual screen.

In at least one example embodiment, the display region of the virtual screen is adjacent to the circumferential span region of the virtual screen.

In at least one example embodiment, the display region of the virtual screen, at least partially, corresponds with the flexible display.

In at least one example embodiment, the entirety of the circumferential span region of the virtual screen fails to correspond with the flexible display.

In at least one example embodiment, the portion of the predetermined contiguous content being within the circumferential span region of the virtual screen precludes display of the portion of the predetermined contiguous content within the display region of the virtual screen.

In at least one example embodiment, the entirety of the predetermined contiguous content being within the display region of the virtual screen is associated with display of the entirety of the predetermined contiguous content within the display region of the virtual screen.

In at least one example embodiment, the virtual screen is a screen that is characterized by an area that is larger than an area of a display on which the virtual screen is displayed.

In at least one example embodiment, the determination of the circumferential span comprises determination of a distance between the longitudinal edge and the opposite longitudinal edge.

In at least one example embodiment, the determination of the distance between the longitudinal edge and the opposite longitudinal edge is based, at least in part, on a degree of curvature of the partial cylindrical configuration of the flexible display.

In at least one example embodiment, the determination of the circumferential span comprises determination of a flexural configuration of the flexible display.

In at least one example embodiment, the determination of the flexural configuration of the flexible display is based, at least in part, on a degree of curvature of the partial cylindrical configuration of the flexible display.

In at least one example embodiment, the inertial scroll input is a swipe input.

In at least one example embodiment, the swipe input comprises a contact portion of the swipe input, a movement portion of the swipe input, and a release portion of the swipe input.

In at least one example embodiment, the release portion of the scroll input corresponds with the movement portion of the scroll input.

One or more example embodiments further perform causation of movement of the display region within the virtual screen based, at least in part, on the inertial scroll input.

In at least one example embodiment, the movement of the display region within the virtual screen continues subsequent to the receipt of information indicative of the release portion of the inertial scroll input.

In at least one example embodiment, a speed of the movement of the display region within the virtual screen is proportional to an input speed of the movement portion of the inertial scroll input.

In at least one example embodiment, the movement terminates when the display region of the virtual screen reaches the inertial scroll stop position.

In at least one example embodiment, the inertial scroll stop position is a position of the display region within the virtual screen subsequent to completion of the movement of the display region within the virtual screen.

In at least one example embodiment, the completion of the movement of the display region within the virtual screen is characterized by a speed of the movement reaching zero at the adjusted inertial scroll stop position.

One or more example embodiments further perform determination that a flexible display is configured such that the flexible display is in a flat configuration, initiation of a non-wrapping interaction mode based, at least in part, on the flat configuration, determination that the flexible display has been reconfigured such that the flexible display is in a partial cylindrical configuration, and initiation of a wrapping interaction mode based, at least in part, on the partial cylindrical configuration.

In at least one example embodiment, the non-wrapping interaction mode is associated with at least one of preclusion of scrolling of a virtual screen or preclusion of scrolling of a virtual screen beyond a boundary of the virtual screen.

In at least one example embodiment, the boundary of the virtual screen is at least one of a start of the virtual screen or an end of the virtual screen.

One or more example embodiments further perform, in the non-wrapping interaction mode, receipt of information indicative of an inertial scroll input, determination of an inertial scroll stop position based, at least in part, on the inertial scroll input, determination that the inertial scroll stop position is beyond a boundary of the virtual screen, and determination of an adjusted inertial scroll stop position that corresponds with the boundary of the virtual screen.

In at least one example embodiment, the determination of the adjusted inertial scroll stop position that corresponds with the boundary of the virtual screen is performed such that scrolling beyond the boundary of the virtual screen is precluded.

In at least one example embodiment, the wrapping interaction mode is associated with scrolling of the virtual screen such that scrolling beyond a boundary causes display of information proximate to the opposite boundary.

In at least one example embodiment, the causation of display of information proximate to the opposite boundary is performed such that a start boundary of the virtual screen corresponds with an end boundary of the virtual screen.

One or more example embodiments further perform, in the wrapping interaction mode, receipt of information indicative of an inertial scroll input, determination of an inertial scroll stop position based, at least in part, on the inertial scroll input, determination that the inertial scroll stop position is at a distance beyond a boundary of the virtual screen, and determination of an adjusted inertial scroll stop position that is within the boundary of the virtual screen and at the distance from an opposite boundary of the virtual screen.

One or more example embodiments further perform identification of a longitudinal edge and an opposite longitudinal edge of the flexible display based, at least in part, on the determination that the flexible display has been reconfigured such that the flexible display is in a partial cylindrical configuration, determination of a circumferential span from the longitudinal edge to the opposite longitudinal edge, determination of a circumferential span region of a virtual screen based, at least in part, on the circumferential span, and resizing of the virtual screen based, at least in part, on the circumferential span region.

### BRIEF DESCRIPTION OF THE DRAWINGS

For a more complete understanding of embodiments of the invention, reference is now made to the following descriptions taken in connection with the accompanying drawings in which:

FIG. 1 is a block diagram showing an apparatus according to at least one example embodiment;

FIGS. 2A-2C are diagrams illustrating an apparatus according to at least one example embodiment;

FIG. 3 is a diagram illustrating a cylinder according to at least one example embodiment;

FIGS. 4A-4D are diagrams illustrating a virtual screen and an apparatus according to at least one example embodiment;

FIGS. 5A-5B are diagrams illustrating a virtual screen and an apparatus according to at least one example embodiment;

FIG. 6 is a flow diagram illustrating activities associated with determination of an adjusted inertial scroll stop position according to at least one example embodiment;

FIG. 7 is a flow diagram illustrating activities associated with resizing of a virtual screen according to at least one example embodiment;

FIG. 8 is a flow diagram illustrating activities associated with initiation of a wrapping interaction mode according to at least one example embodiment;

FIG. 9 is a flow diagram illustrating activities associated with determination of an adjusted inertial scroll stop position according to at least one example embodiment;

FIG. 10 is a flow diagram illustrating activities associated with determination of an adjusted inertial scroll stop position according to at least one example embodiment; and

FIG. 11 is a flow diagram illustrating activities associated with resizing of a virtual screen according to at least one example embodiment.

### DETAILED DESCRIPTION OF THE DRAWINGS

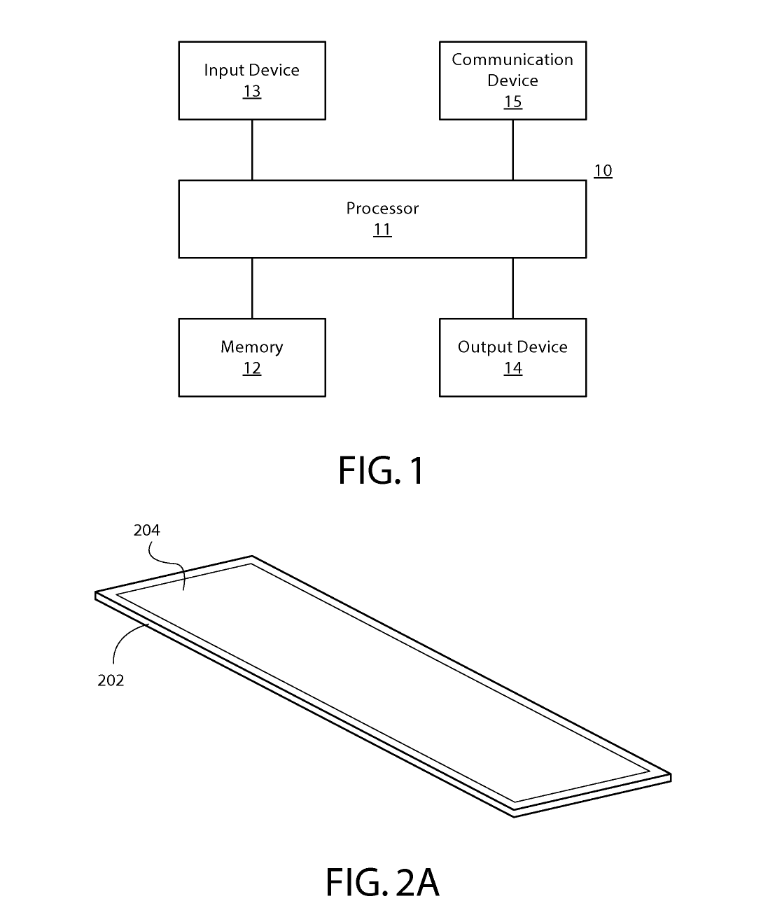

An embodiment of the invention and its potential advantages are understood by referring to FIGS. 1 through 11 of the drawings.

Some embodiments will now be described more fully hereinafter with reference to the accompanying drawings, in which some, but not all, embodiments are shown. Various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network apparatus, other network apparatus, and/or other computing apparatus.

As defined herein, a “non-transitory computer-readable medium,” which refers to a physical medium (e.g., volatile or non-volatile memory device), can be differentiated from a “transitory computer-readable medium,” which refers to an electromagnetic signal.

FIG. 1 is a block diagram showing an apparatus, such as an electronic apparatus 10, according to at least one example embodiment. It should be understood, however, that an electronic apparatus as illustrated and hereinafter described is merely illustrative of an electronic apparatus that could benefit from embodiments of the invention and, therefore, should not be taken to limit the scope of the invention. While electronic apparatus 10 is illustrated and will be hereinafter described for purposes of example, other types of electronic apparatuses may readily employ embodiments of the invention. Electronic apparatus 10 may be a personal digital assistant (PDAs), a pager, a mobile computer, a desktop computer, a television, a gaming apparatus, a laptop computer, a tablet computer, a media player, a camera, a video recorder, a mobile phone, a global positioning system (GPS) apparatus, a flexible apparatus, a deformable apparatus, a wrist worn apparatus, an arm worn apparatus, an automobile, a kiosk, an electronic table, and/or any other types of electronic systems. Moreover, the apparatus of at least one example embodiment need not be the entire electronic apparatus, but may be a component or group of components of the electronic apparatus in other example embodiments. For example, the apparatus may be an integrated circuit, a set of integrated circuits, and/or the like.

Furthermore, apparatuses may readily employ embodiments of the invention regardless of their intent to provide mobility. In this regard, even though embodiments of the invention may be described in conjunction with mobile applications, it should be understood that embodiments of the invention may be utilized in conjunction with a variety of other applications, both in the mobile communications industries and outside of the mobile communications industries. For example, the apparatus may be, at least part of, a non-carryable apparatus, such as a large screen television, an electronic table, a kiosk, an automobile, and/or the like.

In at least one example embodiment, electronic apparatus 10 comprises processor 11 and memory 12. Processor 11 may be any type of processor, controller, embedded controller, processor core, and/or the like. In at least one example embodiment, processor 11 utilizes computer program code to cause an apparatus to perform one or more actions. Memory 12 may comprise volatile memory, such as volatile Random Access Memory (RAM) including a cache area for the temporary storage of data and/or other memory, for example, non-volatile memory, which may be embedded and/or may be removable. The non-volatile memory may comprise an EEPROM, flash memory and/or the like. Memory 12 may store any of a number of pieces of information, and data. The information and data may be used by the electronic apparatus 10 to implement one or more functions of the electronic apparatus 10, such as the functions described herein. In at least one example embodiment, memory 12 includes computer program code such that the memory and the computer program code are configured to, working with the processor, cause the apparatus to perform one or more actions described herein.

The electronic apparatus 10 may further comprise a communication device 15. In at least one example embodiment, communication device 15 comprises an antenna, (or multiple antennae), a wired connector, and/or the like in operable communication with a transmitter and/or a receiver. In at least one example embodiment, processor 11 provides signals to a transmitter and/or receives signals from a receiver. The signals may comprise signaling information in accordance with a communications interface standard, user speech, received data, user generated data, and/or the like. Communication device 15 may operate with one or more air interface standards, communication protocols, modulation types, and access types. By way of illustration, the electronic communication device 15 may operate in accordance with second-generation (2G) wireless communication protocols IS-136 (time division multiple access (TDMA)), Global System for Mobile communications (GSM), and IS-95 (code division multiple access (CDMA)), with third-generation (3G) wireless communication protocols, such as Universal Mobile Telecommunications System (UMTS), CDMA2000, wideband CDMA (WCDMA) and time division-synchronous CDMA (TD-SCDMA), and/or with fourth-generation (4G) wireless communication protocols, wireless networking protocols, such as 802.11, short-range wireless protocols, such as Bluetooth, and/or the like. Communication device 15 may operate in accordance with wireline protocols, such as Ethernet, digital subscriber line (DSL), asynchronous transfer mode (ATM), and/or the like.

Processor 11 may comprise means, such as circuitry, for implementing audio, video, communication, navigation, logic functions, and/or the like, as well as for implementing embodiments of the invention including, for example, one or more of the functions described herein. For example, processor 11 may comprise means, such as a digital signal processor device, a microprocessor device, various analog to digital converters, digital to analog converters, processing circuitry and other support circuits, for performing various functions including, for example, one or more of the functions described herein. The apparatus may perform control and signal processing functions of the electronic apparatus 10 among these devices according to their respective capabilities. The processor 11 thus may comprise the functionality to encode and interleave message and data prior to modulation and transmission. The processor 1 may additionally comprise an internal voice coder, and may comprise an internal data modem. Further, the processor 11 may comprise functionality to operate one or more software programs, which may be stored in memory and which may, among other things, cause the processor 11 to implement at least one embodiment including, for example, one or more of the functions described herein. For example, the processor 11 may operate a connectivity program, such as a conventional internet browser. The connectivity program may allow the electronic apparatus 10 to transmit and receive internet content, such as location-based content and/or other web page content, according to a Transmission Control Protocol (TCP), Internet Protocol (IP), User Datagram Protocol (UDP), Internet Message Access Protocol (IMAP), Post Office Protocol (POP), Simple Mail Transfer Protocol (SMTP), Wireless Application Protocol (WAP), Hypertext Transfer Protocol (HTTP), and/or the like, for example.

The electronic apparatus 10 may comprise a user interface for providing output and/or receiving input. The electronic apparatus 10 may comprise an output device 14. Output device 14 may comprise an audio output device, such as a ringer, an earphone, a speaker, and/or the like. Output device 14 may comprise a tactile output device, such as a vibration transducer, an electronically deformable surface, an electronically deformable structure, and/or the like. Output device 14 may comprise a visual output device, such as a display, a light, and/or the like. In at least one example embodiment, the apparatus causes display of information, the causation of display may comprise displaying the information on a display comprised by the apparatus, sending the information to a separate apparatus that comprises a display, and/or the like. The electronic apparatus may comprise an input device 13. Input device 13 may comprise a light sensor, a proximity sensor, a microphone, a touch sensor, a force sensor, a button, a keypad, a motion sensor, a magnetic field sensor, a camera, and/or the like. A touch sensor and a display may be characterized as a touch display. In an embodiment comprising a touch display, the touch display may be configured to receive input from a single point of contact, multiple points of contact, and/or the like. In such an embodiment, the touch display and/or the processor may determine input based, at least in part, on position, motion, speed, contact area, and/or the like. In at least one example embodiment, the apparatus receives an indication of an input. The apparatus may receive the indication from a sensor, a driver, a separate apparatus, and/or the like. The information indicative of the input may comprise information that conveys information indicative of the input, indicative of an aspect of the input indicative of occurrence of the input, and/or the like.

The electronic apparatus 10 may include any of a variety of touch displays including those that are configured to enable touch recognition by any of resistive, capacitive, infrared, strain gauge, surface wave, optical imaging, dispersive signal technology, acoustic pulse recognition or other techniques, and to then provide signals indicative of the location and other parameters associated with the touch. Additionally, the touch display may be configured to receive an indication of an input in the form of a touch event which may be defined as an actual physical contact between a selection object (e.g., a finger, stylus, pen, pencil, or other pointing device) and the touch display. Alternatively, a touch event may be defined as bringing the selection object in proximity to the touch display, hovering over a displayed object or approaching an object within a predefined distance, even though physical contact is not made with the touch display. As such, a touch input may comprise any input that is detected by a touch display including touch events that involve actual physical contact and touch events that do not involve physical contact but that are otherwise detected by the touch display, such as a result of the proximity of the selection object to the touch display. A touch display may be capable of receiving information associated with force applied to the touch screen in relation to the touch input. For example, the touch screen may differentiate between a heavy press touch input and a light press touch input. In at least one example embodiment, a display may display two-dimensional information, three-dimensional information and/or the like.

In embodiments including a keypad, the keypad may comprise numeric (for example, 0-9) keys, symbol keys (for example, #, *), alphabetic keys, and/or the like for operating the electronic apparatus 10. For example, the keypad may comprise a conventional QWERTY keypad arrangement. The keypad may also comprise various soft keys with associated functions. In addition, or alternatively, the electronic apparatus 10 may comprise an interface device such as a joystick or other user input interface.

Input device 13 may comprise a media capturing element. The media capturing element may be any means for capturing an image, video, and/or audio for storage, display or transmission. For example, in at least one example embodiment in which the media capturing element is a camera module, the camera module may comprise a digital camera which may form a digital image file from a captured image. As such, the camera module may comprise hardware, such as a lens or other optical component(s), and/or software necessary for creating a digital image file from a captured image. Alternatively, the camera module may comprise only the hardware for viewing an image, while a memory device of the electronic apparatus 10 stores instructions for execution by the processor 11 in the form of software for creating a digital image file from a captured image. In at least one example embodiment, the camera module may further comprise a processing element such as a co-processor that assists the processor 11 in processing image data and an encoder and/or decoder for compressing and/or decompressing image data. The encoder and/or decoder may encode and/or decode according to a standard format, for example, a Joint Photographic Experts Group (JPEG) standard format.

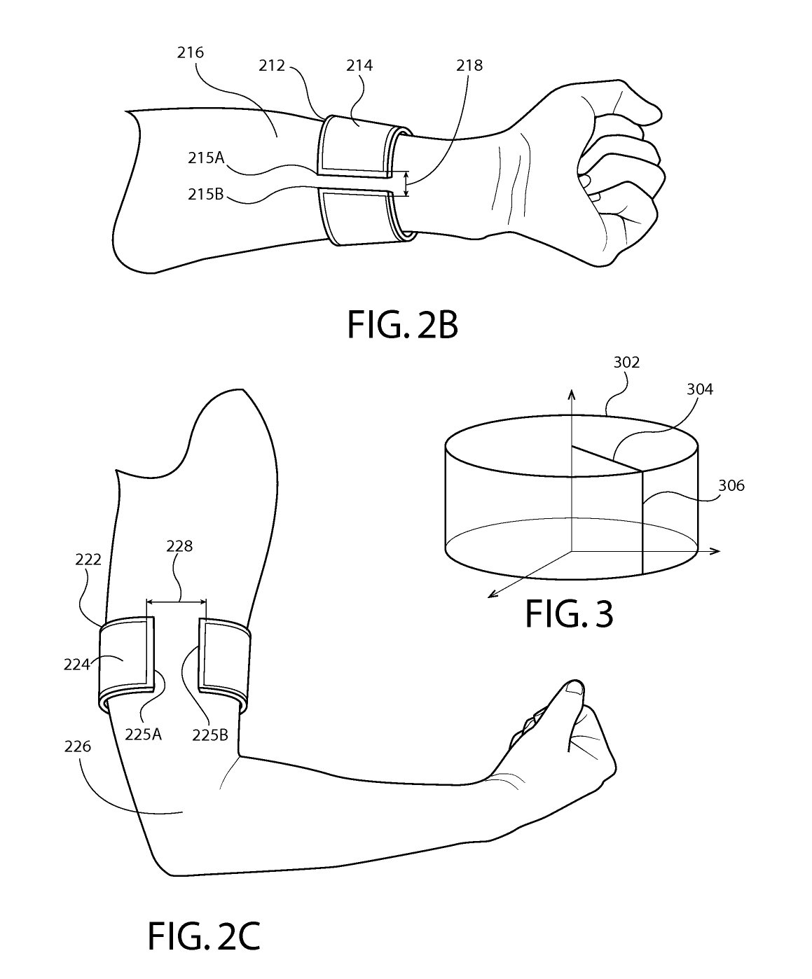

FIGS. 2A-2C are diagrams illustrating an apparatus according to at least one example embodiment. The examples of FIGS. 2A-2C are merely examples and do not limit the scope of the claims. For example, apparatus configuration may vary, apparatus design may vary, apparatus proportions may vary, display configuration may vary, and/or the like.

Over the years, electronic apparatuses have become increasingly prevalent in our society. As a result, many users of electronic apparatuses have become increasingly reliant upon their electronic apparatuses for purposes relating to communication, scheduling, etc. As such, users of electronic apparatuses may desire electronic apparatuses that provide robust interaction capabilities, large displayed, convenient access, and/or the like.

FIG. 2A is a diagram illustrating an apparatus according to at least one example embodiment. In the example of FIG. 2A, apparatus 202 is an electronic apparatus, such as a tablet, a phone, a music player, a wearable apparatus, and/or the like. As can be seen, apparatus 202 comprises display 204. A user of apparatus 202 may view content by way of display 204, may interact with content by way of display 204, and/or the like. For example, display 204 may be a touch display, and a user may interact with content displayed by way of display 204 by tapping, swiping, dragging, and/or the like on display 204. As can be seen, apparatus 202 is in a flat configuration. In at least one example embodiment, a flat configuration is a configuration in which the apparatus avoids flexure, precludes deformation, and/or the like. For example, apparatus 202, as depicted in the example of FIG. 2A, may maintain the configuration depicted and may avoid flexure, curvature, deformation, and/or the like.

As electronic apparatuses become increasing prevalent and pervasive in our society, a user of an electronic apparatus may desire to have continuous and/or convenient access to her electronic apparatus. For example, a user may desire to have quick access to the user's electronic apparatus without having to fetch the electronic apparatus from the user's purse. In another example, an electronic apparatus may be sized such that a user of the electronic apparatus may be unable to stow the electronic apparatus in the user's pocket for convenient access. In this manner, it may be desirable to configure an electronic apparatus such that a user of the electronic apparatus may conveniently carry and/or utilize the electronic apparatus in a manner that is easy and intuitive.

In many circumstances, it may be desirable to configure an electronic apparatus such that the electronic apparatus may be flexed, deformed, and/or the like. For example, a user of the electronic apparatus may desire to flex the electronic apparatus around the user's wrist, arm, etc. such that the electronic apparatus may be worn by the user on the user's wrist, arm, etc. In at least one example embodiment, an apparatus comprises a flexible display. For example, the flexible display may be a display that is configured to flex in at least one dimension. In such an example, a user of the apparatus may flex the apparatus, fold the apparatus, deform the apparatus, and/or the like. For example, the user of the apparatus may configure the apparatus such that the apparatus is flexed in a partial cylindrical configuration. A partial cylindrical configuration may a configuration of the apparatus such that the apparatus forms a cylindrical shape, a partial cylindrical shape, and/or the like. The partial cylindrical configuration may be a partial circular cylindrical configuration, a partial elliptical cylindrical configuration, a partial octagonal cylindrical configuration, and/or the like. The partial cylindrical configuration may be symmetrical, asymmetrical, and/or the like.

FIG. 2B is a diagram illustrating an apparatus according to at least one example embodiment. In the example of FIG. 2B, apparatus 212 comprises display 214. In the example of FIG. 2B, display 214 is a flexible display. As can be seen, apparatus 212 is flexed in a partial cylindrical configuration such that apparatus 212 is flexed around wrist 216 of a user, is worn on wrist 216 of the user, is removably coupled to wrist 216 of the user, and/or the like.

In some circumstances, an apparatus may be configured such that the apparatus may be flexed in more than one dimension. For example, as illustrated in FIG. 2A, apparatus 202 may be configured to flex along the long axis, along the short axis, and/or the like. As such, it may be desirable to determine a specific partial cylindrical configuration of the apparatus, characteristics associated with a particular partial cylindrical configuration, and/or the like. In at least one example embodiment, an apparatus identifies a longitudinal edge and an opposite longitudinal edge of a flexible display that is flexed such that the flexible display is in a partial cylindrical configuration. The longitudinal edge may be an edge of the flexible display that is perpendicular to a circumference of the flexible display in the partial cylindrical configuration, perpendicular to a circumferential edge of the flexible display in the partial cylindrical configuration, and/or the like. The circumference and the longitudinal edge may be similar as described regarding FIG. 3.

In at least one example embodiment, the longitudinal edge is substantially parallel to the opposite longitudinal edge. For example, the longitudinal edge being substantially parallel to the opposite longitudinal edge the longitudinal edge may be associated with the longitudinal edge being parallel to the opposite longitudinal edge within a predefined threshold. For example, a user may configure the apparatus in a partially cylindrical configure such that the longitudinal edge is substantially parallel to the opposite longitudinal edge. In at least one example embodiment, deviation between the longitudinal edge and the opposite longitudinal edge may be within a manufacturing tolerance associated with manufacturing of the flexible display, manufacturing of the apparatus, assembly of the apparatus, and/or the like. For example, the longitudinal edge and the opposite longitudinal edge may be oriented such that the longitudinal edge faces towards the opposite longitudinal edge when the apparatus is configured in the partial cylindrical configuration.

In the example of FIG. 2B, longitudinal edges 215A and 215B are longitudinal edges of display 214. As can be seen, longitudinal edges 215A and 215B are perpendicular to a circumference of display 214 in the partial cylindrical configuration, perpendicular to a circumferential edge of display 214 in the partial cylindrical configuration, and/or the like. As can be seen in the example of FIG. 2B, longitudinal edge 215A is substantially parallel to longitudinal edge 215B when flexed in the partial cylindrical configuration around wrist 216.

In order to facilitate identification of the longitudinal edge and the opposite longitudinal edge, it may be desirable to determine a manner in which an apparatus is flexed, a specific partial cylindrical configuration of the apparatus, and/or the like. In at least one example embodiment, the identification of the longitudinal edge and the opposite longitudinal edge comprises retrieval of information indicative of the longitudinal edge and the opposite longitudinal edge. For example, an apparatus may be configured such that the apparatus, the flexible display, etc. is flexible in a single dimension. In such an example, the longitudinal edge and the opposite longitudinal edge may be predetermined, predefined, based on specific product configuration information, and/or the like. For example, a specific edge of the flexible display may be identified as the longitudinal edge, and an opposite edge of the flexible display may be identified as the opposite longitudinal edge.

In some circumstances, an apparatus may be configured such that the apparatus, the flexible display, etc. is flexible in a plurality of dimensions. In such circumstances, it may be desirable to identify the longitudinal edge and/or the opposite longitudinal edge based, at least in part, on a specific configuration of the apparatus, on a specific partial cylindrical configuration of the apparatus, a partial cylindrical configuration of the flexible display, and/or the like. In at least one example embodiment, the identification of the longitudinal edge and the opposite longitudinal edge is based, at least in part, on the partial cylindrical configuration of the flexible display. For example, the apparatus may determine that the flexible display is in a partial cylindrical configuration. In such an example, the apparatus may determine that the flexible display is flexed along a dimension of the flexible display, a different dimension of the flexible display, and/or the like. In this manner, the apparatus may identify the longitudinal edge and/or the opposite longitude edge based, at least in part, on the dimension in which the flexible display is flexed in the partial cylindrical configuration.

In many circumstances, an apparatus that is flexed in a partial cylindrical configuration may fail to fully circumnavigate a user's wrist, arm, etc. For example, the apparatus may be dimensioned such that the circumference of the apparatus in the partial cylindrical configuration is less than the circumference of the user's wrist, arm, etc. In this manner, a gap may exist between the longitudinal edge of the flexible display and the opposite longitudinal edge of the flexible display. In at least one example embodiment, an apparatus determines a circumferential span from the longitudinal edge to the opposite longitudinal edge. The determination of the circumferential span may comprise determination of a distance between the longitudinal edge and the opposite longitudinal edge. For example, the determination of the distance may be based, at least in part, on sensor information that is indicative of the distance between the longitudinal edge and the opposite longitudinal edge. In such an example, the sensor information may be received from at least one of a proximity sensor, a visual sensor, an electromagnetic sensor, etc., such that the apparatus may determine the physical separation between the longitudinal edge and the opposite longitudinal edge.

In at least one example embodiment, the determination of the distance between the longitudinal edge and the opposite longitudinal edge is based, at least in part, on a degree of curvature of the partial cylindrical configuration of the flexible display. For example, the apparatus may determine the circumferential span based, at least in part, on a predefined dimension of the flexible display and the degree of curvature of the partial cylindrical configuration of the flexible display. In such an example, the apparatus may calculate the circumferential span, may determine the circumferential span based, at least in part, on predetermined correlations between the degree of curvature and the circumferential span, and/or the like.

In the example of FIG. 2B, circumferential span 218 indicates the span between longitudinal edges 215A and 215B. Circumferential span 218 may be determined based, at least in part, on sensor information received from one or more sensors comprised by apparatus 212, predetermined correlation between a degree of curvature of apparatus 212 and circumferential span 218, and/or the like.

FIG. 2C is a diagram illustrating an apparatus according to at least one example embodiment. In the example of FIG. 2C, apparatus 222 comprises display 224. In the example of FIG. 2C, display 224 is a flexible display. As can be seen, apparatus 222 is flexed in a partial cylindrical configuration such that apparatus 222 is flexed around arm 226 of a user, is worn on arm 226 of the user, is coupled to arm 226 of the user, and/or the like. In the example of FIG. 2C, longitudinal edges 225A and 225B are longitudinal edges of display 224. As can be seen, longitudinal edges 225A and 225B are perpendicular to a circumference of display 224 in the partial cylindrical configuration, perpendicular to a circumferential edge of display 224 in the partial cylindrical configuration, and/or the like. As can be seen in the example of FIG. 2C, longitudinal edge 225A is substantially parallel to longitudinal edge 225B when flexed in the partial cylindrical configuration around arm 226. In the example of FIG. 2C, circumferential span 228 indicates the span between longitudinal edges 225A and 225B. Circumferential span 228 may be determined based, at least in part, on sensor information received from one or more sensors comprised by apparatus 222, predetermined correlation between a degree of curvature of apparatus 222 and circumferential span 228, and/or the like. As can be seen, circumferential span 228 of FIG. 2C is larger than circumferential span 218 of FIG. 2B based, at least in part, on the circumference of arm 226 being greater than the circumference of wrist 216. In this manner, flexible display 214 of FIG. 2B may be associated with a greater degree of curvature than flexible display 224 of FIG. 2C.

FIG. 3 is a diagram illustrating a cylinder according to at least one example embodiment. The example of FIG. 3 is merely an example and does not limit the scope of the claims. For example, cylinder proportions may vary, cylinder symmetry may vary, cylinder dimensions may vary, and/or the like.

The example of FIG. 3 depicts a cylinder that is characterized by circumference 302, radius 304, and height 306. As can be seen, certain aspects of a partial cylindrical configuration of a flexible display may be characterized in relation to the cylinder that is depicted in the example of FIG. 3. For example, a longitudinal edge of a flexible display that is flexed in a partial cylindrical configuration may an edge of the flexible display that is parallel to height 306, perpendicular to radius 304, perpendicular to circumference 302, and/or the like. A circumferential edge of a flexible display that is flexed in a partial cylindrical configuration may be an edge of the flexible display that is perpendicular to a longitudinal edge of the flexible display, that substantially corresponds with circumference 302, and/or the like.

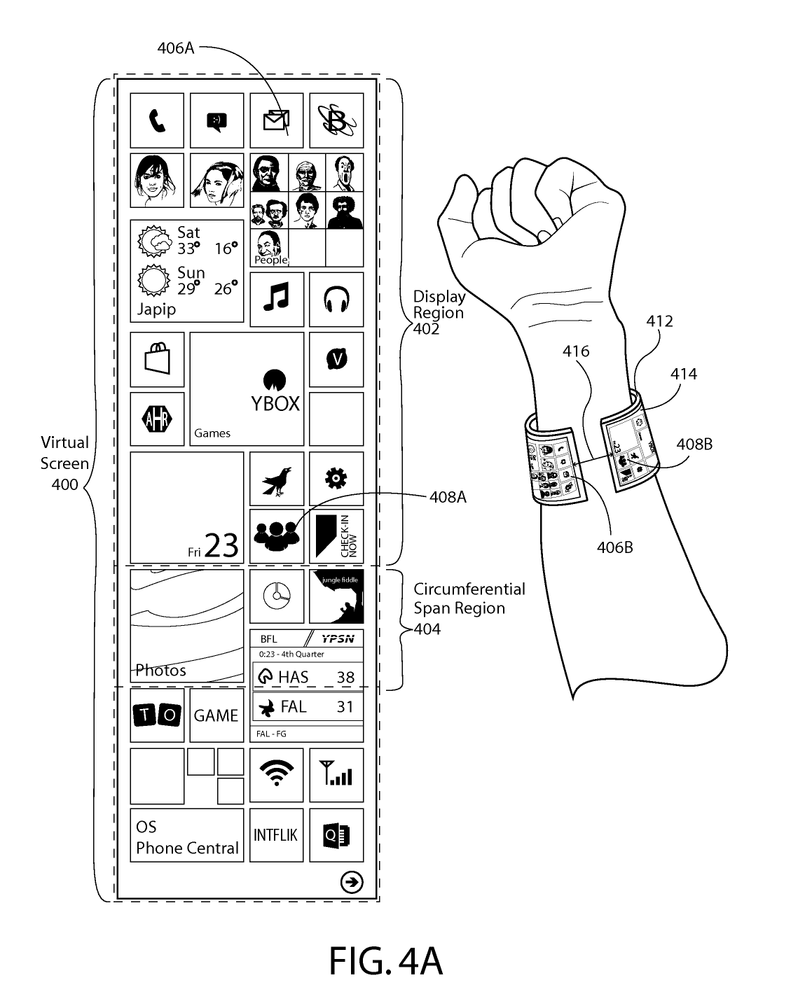

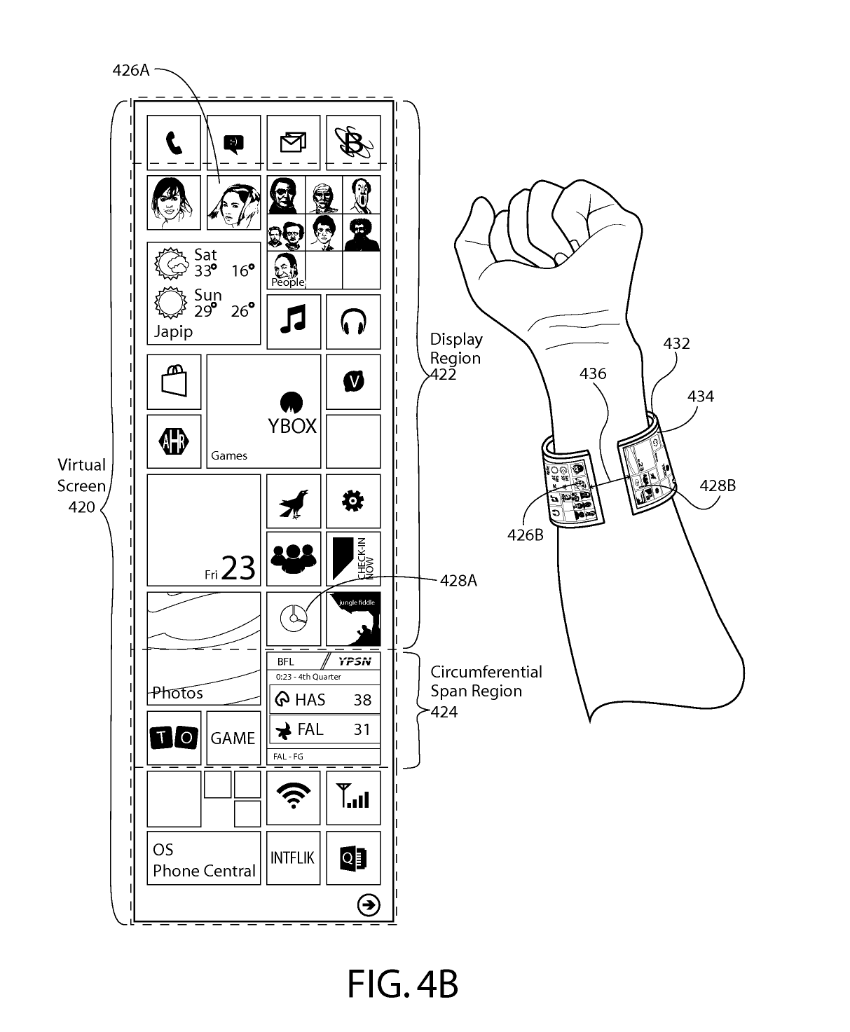

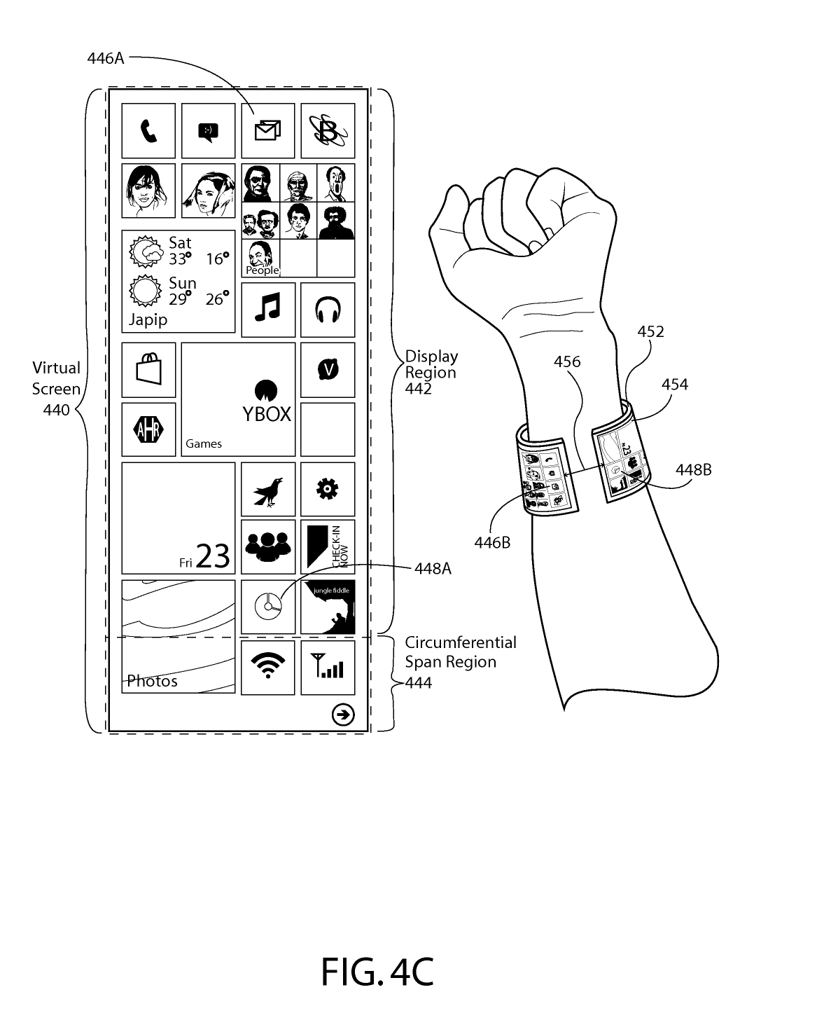

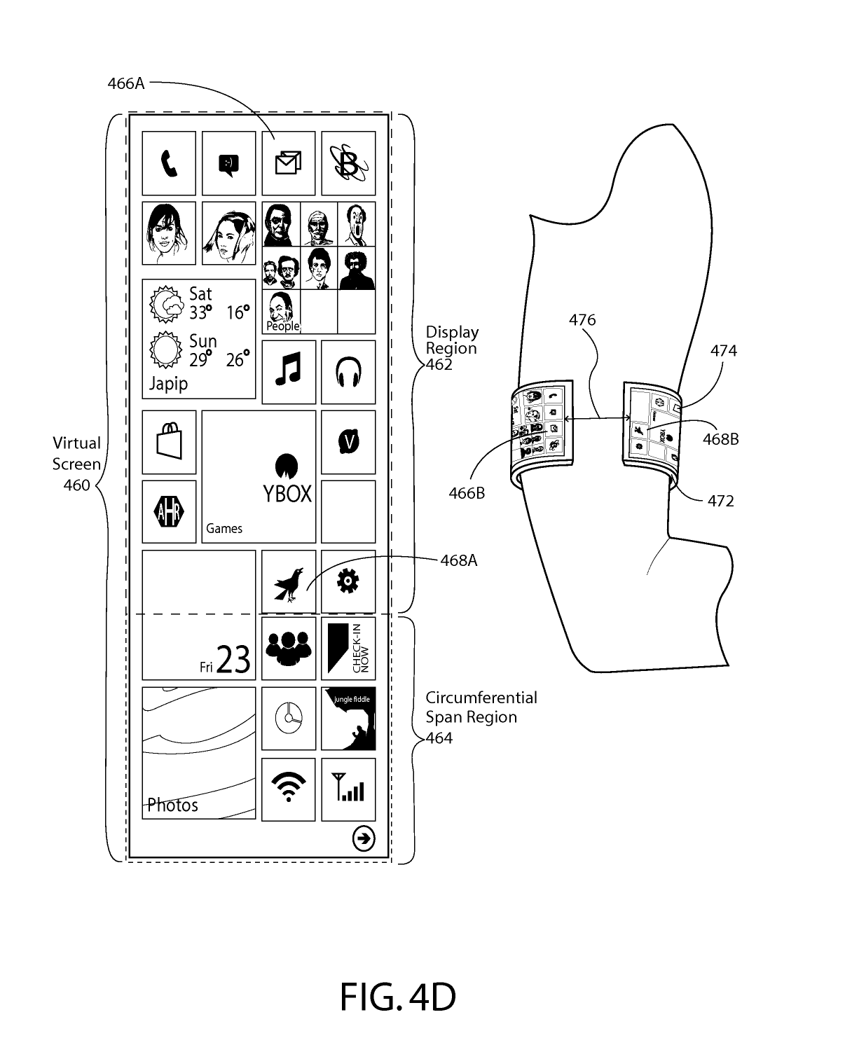

FIGS. 4A-4D are diagrams illustrating a virtual screen and an apparatus according to at least one example embodiment. The examples of FIGS. 4A-4D are merely examples and do not limit the scope of the claims. For example, apparatus configuration may vary, apparatus design may vary, virtual screen proportions may vary, circumferential span region configuration may vary, display region configuration may vary, and/or the like.

As discussed previously, in many circumstances, a user may utilize an electronic apparatus for purposes relating to communication, scheduling, etc. In such circumstances, the user may view content, interact with content, etc. by way of the flexible display. In many circumstances, the flexible display may have different dimensions than the information to be displayed on the flexible display. For example, the flexible display may be dimensioned such that the flexible display may be unable to display the entirety of the content that the user desires to view, interact with, and/or the like. In such an example, the content may be too large, too long, and/or the like. In such an example, it may be desirable to configure an electronic apparatus such that a user of the electronic apparatus may view and/or interact with the entirety of the content by way of panning within a virtual screen. In at least one example embodiment, a virtual screen is a screen that is characterized by an area that is larger than an area of a display on which the virtual screen is displayed. In such an example embodiment, a portion of the virtual screen may be displayed at a given time on the display. Panning within the virtual screen may cause displaying of a different portion of the virtual screen on the display. For example, the virtual screen may comprise visual information indicative of a map. In such an example, a user may desire to pan horizontally, vertically, diagonally, and/or the like, within the virtual screen such that the user may perceive various portions of the map that may be displayed on a display.

As discussed previously, in many circumstances, a flexible display that is configured in a partial cylindrical configuration may be associated with a circumferential span between a longitudinal edge of the flexible display and an opposite longitudinal edge of the flexible display. In such circumstances, a user may perceive the flexible display such that the circumferential span is visible to the user. For example, the user may perceive content that is displayed on a portion of the flexible display separated from content that is displayed on a different portion of the flexible display by the circumferential span. In such an example, the user may interact with the content being displayed, may scroll through the content that is being displayed, and/or the like. As such, it may be desirable to configure an apparatus such that a user of the apparatus may view content, interact with content, and/or the like, in a manner that allows for natural navigation, intuitive scrolling of content, and/or the like. In at least one example embodiment, a virtual screen comprises a display region of the virtual screen and a circumferential span region of the virtual screen. The display region of the virtual screen may be a portion of the virtual screen that is displayed on a display, is perceivable by a user, and/or the like. The circumferential span region of the virtual screen may be a portion of the virtual screen that corresponds with the circumferential span. In at least one example embodiment, an apparatus determines a circumferential span region of a virtual screen based, at least in part, on the circumferential span.

The display region of the virtual screen may be distinct from the circumferential span region of the virtual screen, may fail to overlap the circumferential span region of the virtual screen, may be adjacent to the circumferential span region of the virtual screen, and/or the like. For example, the display region of the virtual screen may, at least partially, correspond with the flexible display, and the entirety of the circumferential span region of the virtual screen may fail to correspond with the flexible display.

FIG. 4A is a diagram illustrating a virtual screen and an apparatus according to at least one example embodiment. The example of FIG. 4A depicts virtual screen 400, which comprises display region 402 and circumferential span region 404. The example of FIG. 4A also depicts apparatus 412, which comprises display 414. As can be seen, display 414 is a flexible display that is flexed in a partial cylindrical configuration around a wrist of a user of apparatus 412. As can be seen, display region 402 comprises icon 406A and icon 408A, which correspond with icon 406B and icon 408B, respectively, as displayed on display 414 of apparatus 412. In the example of FIG. 4A, icon 406A is positioned in a row of icons at the top of display region 402, and icon 408A is positioned in a row of icons at the bottom of display region 402. In this manner, icon 406B and icon 408B are each proximate to a longitudinal edge of display 414.

In the example of FIG. 4A, circumferential span region 404 corresponds with circumferential span 416. For example, circumferential span region 404 may be proportional to circumferential span 416, may be based, at least in part, on circumferential span 416, and/or the like. As can be seen in the example of FIG. 4A, a portion of virtual screen 400 fails to correspond with display region 402, circumferential span region 404, and/or the like. In this manner, the specific portion of virtual screen 400 fails to be displayed on display 414 of apparatus 412, is precluded from display on display 414 of apparatus 412, fails to correspond with circumferential span region 404, and/or the like.

As discussed previously, in many circumstances, a user of an electronic apparatus may desire to view content that may not be displayed in its entirety by way of a display. For example, the display may be dimensioned such that the display area of the display is insufficiently large to display the entirety of the content that the user desires to perceive. In such an example, the user may desire to pan through the content, to scroll through the content, and/or the like. For example, the user may selectively pan the display region of the virtual screen within the virtual screen such that the user may perceive the entirety of the content. In order to facilitate such perception of content, it may be desirable to allow a user to indicate such a desire to pan the display region of the virtual screen, to scroll through the content, and/or the like. In at least on example embodiment, an apparatus receives information indicative of an inertial scroll input. The inertial scroll input may be, for example, a swipe input. In such an example, the swipe input may comprise a contact portion of the swipe input, a movement portion of the swipe input, and a release portion of the swipe input. In at least one example embodiment, the release portion of the scroll input corresponds with the movement portion of the scroll input. For example, the user may lift the user's finger while the user is moving the user's finger across the display. In at least one example embodiment, an apparatus causes movement of the display region within the virtual screen based, at least in part, on the inertial scroll input.

In order to provide a user with an efficient and intuitive scrolling experience, it may be desirable to base the movement of the display region on movements that the user may be familiar with, such as inertial movement, momentum-based slowing, and/or the like. For example, the movement of the display region within the virtual screen may continue subsequent to the receipt of information indicative of the release portion of the inertial scroll input. In at least one example embodiment, a speed of the movement of the display region within the virtual screen is proportional to an input speed of the movement portion of the inertial scroll input. In such an example embodiment, subsequent to the release portion of the inertial scroll input, the speed of the movement of the display region within the virtual screen may be iteratively reduced over a period of time such that the speed of the movement reaches zero upon elapsing of the period of time. In this manner, the decrease in the speed of the movement may be based, at least in part, on a drag parameter, a speed decrement parameter, a predefined period of time associated with attainment of a speed of zero, and/or the like.

In order to facilitate perception of content subsequent to movement of the display region of the virtual screen, it may be desirable to halt movement of the display region at a particular position within the virtual screen. In at least one example embodiment, an apparatus determines an inertial scroll stop position based, at least in part, on the inertial scroll input. The inertial scroll stop position may be a position of the display region within the virtual screen subsequent to completion of the movement of the display region within the virtual screen. For example, the movement may terminate when the display region of the virtual screen reaches the inertial scroll stop position. In this manner, the completion of the movement of the display region within the virtual screen may be characterized by a speed of the movement reaching zero at the adjusted inertial scroll stop position. For example, the movement of the display region within the virtual screen may terminate upon receipt of the release portion of the inertial scroll input, may gradually slow to a stop at some point in time subsequent to receipt of the release portion of the inertial scroll input, and/or the like.

In some circumstances, a user of an apparatus may desire to scroll to a particular portion of the virtual screen. For example, the user may desire to cause movement of the display region of the virtual screen such that the display region corresponds with an image, a user interface element, an icon, and/or the like. In such an example, it may be desirable to discontinue movement of the display region of the virtual screen such that the entirety of the image, the user interface element, the icon, and/or the like, corresponds with the display region of the virtual screen. In this manner, the user of the apparatus may be able to perceive the entirety of the image, the user interface element, the icon, and/or the like, by way of a display comprised by the apparatus. In at least one example embodiment, an apparatus determines that an inertial scroll stop position corresponds with, at least a portion of, predetermined contiguous content being within the circumferential span region of the virtual screen. The predetermined contiguous content may be content that is designated to be displayed in a contiguous manner. For example, the predetermined contiguous content may be a toolbar, an image, a user interface element, an icon, and/or the like. In such an example, display of the predetermined contiguous content in the contiguous manner may refer to display of the predetermined contiguous content such that the predetermined contiguous content avoids a boundary of the display region intersecting with the predetermined contiguous content. For example, the portion of the predetermined contiguous content being within the circumferential span region of the virtual screen may preclude display of the portion of the predetermined contiguous content on the flexible display, preclude the portion of the predetermined contiguous content from corresponding with the display region of the virtual screen, and/or the like.

In this manner, it may be desirable to modify the inertial scroll stop position such that the entirety of the predetermined contiguous content is within the display region, the predetermined contiguous content fails to correspond with the circumferential span region, and/or the like. In at least one example embodiment, an apparatus determines an adjusted inertial scroll stop position such that the entirety of the predetermined contiguous content is within a display region of the virtual screen. For example, the entirety of the predetermined contiguous content being within the display region of the virtual screen may be associated with display of the entirety of the predetermined contiguous content within the display region of the virtual screen. In at least one example embodiment, the apparatus causes display of the display region of the virtual screen on the flexible display. The display of the display region of the virtual screen may be continuous, such that the user may perceive the movement of the display region within the virtual screen, may perceive the display region prior to and/or subsequent to receipt of the inertial scroll input, and/or the like. In this manner, the user of the apparatus may be able to perceive the entirety of the predetermined contiguous content by way of the flexible display.

FIG. 4B is a diagram illustrating a virtual screen and an apparatus according to at least one example embodiment. The example of FIG. 4B depicts virtual screen 420, which comprises display region 422 and circumferential span region 424. The example of FIG. 4B also depicts apparatus 432, which comprises display 434. As can be seen, display 434 is a flexible display that is flexed in a partial cylindrical configuration around a wrist of a user of apparatus 432. As can be seen, display region 422 comprises icon 426A and icon 428A, which correspond with icon 426B and icon 428B, respectively, as displayed on display 434 of apparatus 432. In the example of FIG. 4B, icon 426A is positioned in a row of icons at the top of display region 422, and icon 428A is positioned in a row of icons at the bottom of display region 422. In this manner, icon 426B and icon 428B are each proximate to a longitudinal edge of display 434.

In the example of FIG. 4B, circumferential span region 424 corresponds with circumferential span 436. For example, circumferential span region 424 may be proportional to circumferential span 436, may be based, at least in part, on circumferential span 436, and/or the like. As can be seen in the example of FIG. 4B, a portion of virtual screen 420 fails to correspond with display region 422, circumferential span region 424, and/or the like. In this manner, the specific portion of virtual screen 420 fails to be displayed on display 434 of apparatus 432, is precluded from display on display 434 of apparatus 432, fails to correspond with circumferential span region 424, and/or the like.

As can be seen, FIG. 4B corresponds with the example of FIG. 4A subsequent to movement of display region 402 of FIG. 4A within virtual screen 400 of FIG. 4A. For example, display region 402 of FIG. 4A within virtual screen 400 of FIG. 4A may have been moved in a downward direction such that the row of icons in which icon 428A is positioned corresponds with display region 402 of FIG. 4A. In the example of FIG. 4B, icon 428A may be predetermined contiguous content. For example, the user of apparatus 432 may have indicated the user's desire to pan through the virtual screen by way of an inertial scroll input. In such an example, the inertial scroll input may have been of insufficient magnitude to pan such that the entirety of icon 428A would have been positioned within display region 422. In this manner, the apparatus may have determined an adjusted inertial scroll stop position such that the entirety of icon 428A is associated with display region 422, that icon 428A entirely fails to correspond with circumferential span region 424, and/or the like.

In some circumstances, a size of the virtual screen may correspond with a size of the combination of the display region and the circumferential span region. For example, the virtual screen may fail to comprise content that fails to correspond with the combination of the display region of the virtual screen and the circumferential span region of the virtual screen. In this manner, movement of the display region within the virtual screen may cause movement of content from the display region of the virtual screen to the circumferential span region of the virtual screen, and vice versa, such that the entirety of the virtual screen is associated with the combination of the display region and the circumferential span region.

FIG. 4C is a diagram illustrating a virtual screen and an apparatus according to at least one example embodiment. The example of FIG. 4C depicts virtual screen 440, which comprises display region 442 and circumferential span region 444. The example of FIG. 4C also depicts apparatus 452, which comprises display 454. As can be seen, display 454 is a flexible display that is flexed in a partial cylindrical configuration around a wrist of a user of apparatus 452. As can be seen, display region 442 comprises icon 446A and icon 448A, which correspond with icon 446B and icon 448B, respectively, as displayed on display 454 of apparatus 452. In the example of FIG. 4C, icon 446A is positioned in a row of icons at the top of display region 442, and icon 448A is positioned in a row of icons at the bottom of display region 442. In this manner, icon 446B and icon 448B are each proximate to a longitudinal edge of display 454.

In the example of FIG. 4C, circumferential span region 444 corresponds with circumferential span 456. For example, circumferential span region 444 may be proportional to circumferential span 456, may be based, at least in part, on circumferential span 456, and/or the like. As can be seen in the example of FIG. 4C, the entirety of virtual screen 440 corresponds with the combination of display region 442 and circumferential span region 444. In this manner, the entirety of the content comprised by virtual screen 440 corresponds with the combination of display region 442 and circumferential span region 444.

As discussed previously, in some circumstances, a flexible display may be reconfigured such that the circumferential span between a longitudinal edge of the flexible display and an opposite longitudinal edge of the flexible display increased, decreases, and/or the like. In at least one example embodiment, an apparatus determines that the flexible display has been reconfigured such that the flexible display is in a different partial cylindrical configuration. For example, a flexible display in a partial cylindrical configuration that is characterized by a circumferential span may be reconfigured by a user such that the flexible display is configured in a different partial cylindrical configuration that is characterized by a different circumferential span. In such an example, the apparatus may determine a different circumferential span from the longitudinal edge to the opposite longitudinal edge subsequent to the reconfiguration of the flexible display. For example, the determination of the different circumferential span from the longitudinal edge to the opposite longitudinal edge may be based, at least in part, on the determination that the flexible display has been reconfigured such that the flexible display is in the different partial cylindrical configuration. In such an example embodiment, the apparatus may determine a different circumferential span region of the virtual screen based, at least in part, on the different circumferential span.

In such circumstances the size of the virtual screen may change based, at least in part, on the reconfiguration of the flexible display. For example, the circumferential span region of the virtual screen may increase in size, decrease in size, and/or the like. In such an example, the change in size of the circumferential span region may correspond with the change of the circumferential span. In order to provide a user of the apparatus with a seamless viewing experience, it may be desirable to resize the virtual screen, resize the contents of the virtual screen, etc., such that the virtual screen continues to directly correspond with the display region and the circumferential span region of the virtual screen. In at least one example embodiment, an apparatus resizes the virtual screen based, at least in part, on the circumferential span region and the different circumferential span region. For example, the apparatus may increase the size of the virtual screen, may increase the size of the content of the virtual screen, may increase space between content of the virtual screen, may decrease the size of the virtual screen, may decrease the size of the content of the virtual screen, may decrease space between content of the virtual screen, and/or the like.

FIG. 4D is a diagram illustrating a virtual screen and an apparatus according to at least one example embodiment. The example of FIG. 4D depicts virtual screen 460, which comprises display region 462 and circumferential span region 464. The example of FIG. 4D also depicts apparatus 472, which comprises display 474. As can be seen, display 474 is a flexible display that is flexed in a partial cylindrical configuration around a wrist of a user of apparatus 472. As can be seen, display region 462 comprises icon 466A and icon 468A, which correspond with icon 466B and icon 468B, respectively, as displayed on display 474 of apparatus 472. In the example of FIG. 4D, icon 466A is positioned in a row of icons at the top of display region 462, and icon 468A is positioned in a row of icons at the bottom of display region 462. In this manner, icon 466B and icon 468B are each proximate to a longitudinal edge of display 474.

In the example of FIG. 4D, circumferential span region 464 corresponds with circumferential span 476. For example, circumferential span region 464 may be proportional to circumferential span 476, may be based, at least in part, on circumferential span 476, and/or the like. As can be seen in the example of FIG. 4D, the entirety of virtual screen 460 corresponds with the combination of display region 462 and circumferential span region 464. In this manner, the entirety of the content comprised by virtual screen 460 corresponds with the combination of display region 462 and circumferential span region 464.

The example of FIG. 4D depicts the example of FIG. 4C subsequent to reconfiguration of apparatus 452 of FIG. 4C to the partial cylindrical configuration of apparatus 472, depicted in the example of FIG. 4D. As can be seen, the user has moved the apparatus from the user's wrist to the user's arm. As the circumference of the user's arm is larger than the circumference of the user's wrist, the circumferential span between the longitudinal edge and the opposite longitudinal edge of the flexible display has increased. As a result, and as can be seen in the examples of FIG. 4C and FIG. 4D, virtual screen 440 of FIG. 4C has been resized to the size depicted in the example of FIG. 4D. For example, the spacing between the icons comprised by virtual screen 460 may have been increased, the dimensions of the icons may have been stretched to fill virtual screen 460 subsequent to resizing, and/or the like. In this manner, icon 448A of FIG. 4C has shifted to correspond with circumferential span region 464 of FIG. 4D, and icon 468A of FIG. 4D, previously in the third row in FIG. 4C, is displayed in the last row of icons within display region 462 of FIG. 4D.

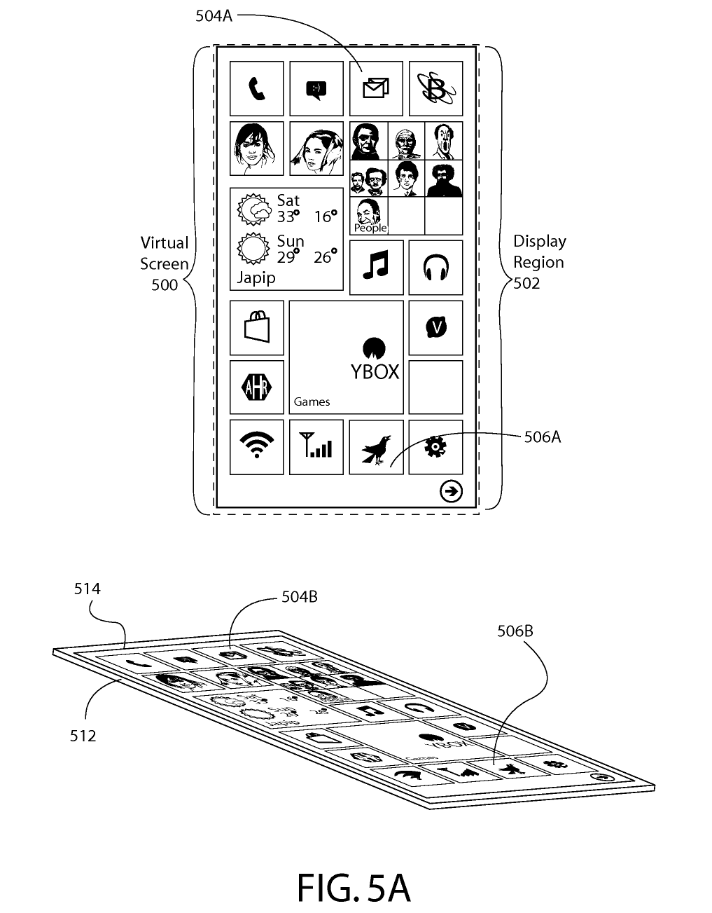

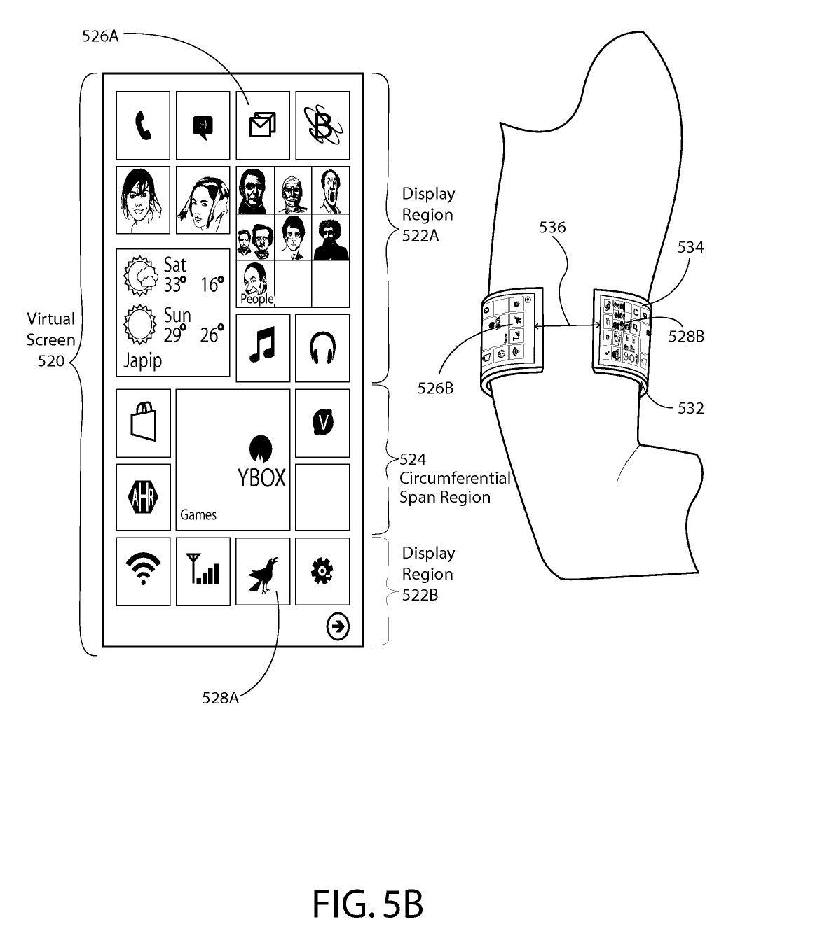

FIGS. 5A-5B are diagrams illustrating a virtual screen and an apparatus according to at least one example embodiment. The examples of FIGS. 5A-5B are merely examples and do not limit the scope of the claims. For example, apparatus configuration may vary, apparatus design may vary, virtual screen proportions may vary, circumferential span region configuration may vary, display region configuration may vary, and/or the like.

In some circumstances, it may be desirable provide a user with an interaction mode that may be well suited for a particular configuration of a flexible display. For example, an interaction mode that may be intuitive when the flexible display is flexed in a partial cylindrical configuration may fail to be intuitive when the flexible display is configured in a flat configuration. As such, it may be desirable to configure the apparatus such that a user of the apparatus may interact with the apparatus in an intuitive manner whether the apparatus is configured in a partial cylindrical configuration or a flat configuration.

In circumstances in which the apparatus is configured in a flat configuration, it may be desirable to permit a user to interact with content displayed by way of the apparatus in a linear fashion. For example, it may be desirable to permit a user to scroll to the top of the content comprised by a virtual screen, to the bottom of the content comprised by the virtual screen, and/or the like. In circumstances in which the apparatus is configured in a flat configuration, the virtual screen may fail to be associated with a circumferential span region, the circumferential span region may be a region of zero area, and/or the like. In at least one example embodiment, an apparatus determines that a flexible display is configured such that the flexible display is in a flat configuration. In such an example embodiment, the apparatus may initiate a non-wrapping interaction mode based, at least in part, on the flat configuration. The non-wrapping interaction mode may associated with preclusion of scrolling of a virtual screen, preclusion of scrolling of a virtual screen beyond a boundary of the virtual screen, and/or the like. The boundary of the virtual screen may be a start of the virtual screen, an end of the virtual screen, and/or the like. For example, the apparatus may receive information indicative of an inertial scroll input, and determine an inertial scroll stop position based, at least in part, on the inertial scroll input. In such an example, the apparatus may determine that the inertial scroll stop position is beyond a boundary of the virtual screen. In order to preclude scrolling of the virtual screen beyond the start of the virtual screen, the end of the virtual screen, and/or the like, the apparatus may determine an adjusted inertial scroll stop position that corresponds with the boundary of the virtual screen. In effect, a user may be precluded from scrolling beyond the start of the virtual screen and/or beyond the end of the virtual screen, such that the apparatus is precluded from displaying of content beyond the virtual screen, looping of content within the virtual screen, and/or the like. In this manner, the determination of the adjusted inertial scroll stop position that corresponds with the boundary of the virtual screen may be performed such that scrolling beyond the boundary of the virtual screen is precluded.

FIG. 5A is a diagram illustrating a virtual screen and an apparatus according to at least one example embodiment. The example of FIG. 5A depicts virtual screen 500, which comprises display region 502. The example of FIG. 5A also depicts apparatus 512, which comprises display 514. As can be seen, display 514 is a flexible display that is configured in a flat configuration. As can be seen, display region 502 comprises icon 504A and icon 506A, which correspond with icon 504B and icon 506B, respectively, as displayed on display 514 of apparatus 512. In the example of FIG. 5A, icon 504A is positioned in a row of icons at the top of display region 502, and icon 506A is positioned in a row of icons at the bottom of display region 502. In this manner, icon 504B and icon 506B are each proximate to a longitudinal edge of display 514.

As can be seen in the example of FIG. 5A, the entirety of virtual screen 500 corresponds with display region 502 of virtual screen 500. In this manner, the entirety of virtual screen 500 is displayed by way of display 514 of apparatus 512. As the entirety of the virtual screen corresponds with display region 502, is being displayed by way of display 514, and/or the like, a user of apparatus 512 may be precluded from scrolling of display region 502 within virtual screen 500. In this manner, a user interacting with virtual screen 500 by way of an inertial scroll input may fail to cause movement of display region 502 within virtual screen 500, may fail to cause movement of the visual information displayed on display 514, and/or the like.

As discussed previously, in many circumstances, a user may reconfigure an apparatus from a flat configuration to a partial cylindrical configuration. For example, the user may desire to wear the apparatus on the user's wrist, arm, ankle, and/or the like. In at least one example embodiment, an apparatus may determine that the flexible display has been reconfigured such that the flexible display is in a partial cylindrical configuration. In such a configuration, it may be desirable to permit a user to scroll through the virtual screen, to pan the display region within the virtual screen, and/or the like, in a circular fashion such that the user may continuously and cyclically scroll through the virtual screen. In at least one example embodiment, an apparatus initiates a wrapping interaction mode based, at least in part, on the partial cylindrical configuration. The wrapping interaction mode may be associated with scrolling of the virtual screen such that scrolling beyond a boundary causes display of information proximate to the opposite boundary. In such an example embodiment, the causation of display of information proximate to the opposite boundary may be performed such that a start boundary of the virtual screen corresponds with an end boundary of the virtual screen.

For example, the apparatus may receive information indicative of an inertial scroll input, and determine an inertial scroll stop position based, at least in part, on the inertial scroll input. In such an example, the apparatus may determine that the inertial scroll stop position is at a distance beyond a boundary of the virtual screen, and may determine an adjusted inertial scroll stop position that is within the boundary of the virtual screen and at the distance from an opposite boundary of the virtual screen. As such, a portion of the virtual screen that pans beyond the end of the virtual may be positioned proximate to the start of the virtual screen, and a portion of the virtual screen that pans beyond the start of the may be positioned proximate to the end of the virtual screen. In this manner, the content comprised by the virtual screen may be wrapped, looped, and/or the like, such that the display region of the virtual screen may be continuous scrolled from start to end, and back again.

In another example, the virtual screen may comprise visual information, such as textual information, graphical information, and/or the like. Such visual information may be displayed such that the visual information is perceived to me moving in relation to the flexible display. For example, the visual information may be at a position within the virtual screen and, subsequently, moved to a different position within the virtual screen. In such an example, the visual information may be caused to be displayed at a position on the flexible display based, at least in part, on the position within the virtual screen, and subsequently displayed at a different position on the flexible display based, at least in part, on the different position within the virtual screen. The display of the visual information may be such that the visual information dynamically transitions from the position to the different position on the flexible display. In such an example, the position within the virtual screen and the different position within the virtual screen may be positions within a display region of the virtual screen. In some circumstances, the position within the virtual screen and the different position within the virtual screen may be separated by a circumferential span region of the virtual screen, such that transitioning from the position within the display region of the virtual screen to the different position within the display region of the virtual screen is associated with movement through the circumferential span region of the virtual screen. In this manner, at least a portion of the visual information may be within the circumferential span region of the virtual screen and, thus, fail to be displayed on the flexible display.

For example, a display region of a virtual screen may comprise visual information indicative of a time of day such that the time of day is caused to be displayed on a flexible display that is flexed in a partial cylindrical configuration. In such an example, the visual information may be displayed such that the visual information moves in a linear fashion around the flexible display. For example, the display position of the visual information on the flexible display may move at a rate of 1 inch per 5 seconds. In such an example, once the visual information reaches a longitudinal edge of the flexible display, at least a portion of the visual information transitions from a position within the display region of the virtual screen to a circumferential span region of the virtual screen, such that the portion of the visual information is precluded from display on the flexible display. If, for example, the circumferential span of the flexible display flexed in the partial cylindrical configuration is 1 inch, the position of the visual information within the virtual screen may continue to move at the rate of 1 inch per 5 seconds, such that the visual information transitions from a position within the circumferential span region of the virtual screen to a position within the display region of the virtual screen. In such an example, at least a portion of the visual information may be displayed a display position that is proximate to the opposite longitudinal edge of the flexible display. In this manner, the visual information may be perceived by a user to move through the circumferential span region of the virtual screen at a rate that is similar to the rate of movement within the display region of the virtual screen and, thus, across the flexible display.

In some circumstances, a user may reconfigure a flexible display from a flat configuration to a partial cylindrical configuration. In such an example, prior to the reconfiguration of the flexible display, the virtual screen may comprise a display region of the virtual screen, and fail to comprise a circumferential span region of the virtual screen. As such, reconfiguration of the flexible display such that the flexible display is flexed in a partial cylindrical configuration may introduce a circumferential span region to the virtual screen, thus increasing the size of the virtual screen. In such circumstances, it may be desirable to resize the virtual screen, resize the contents of the virtual screen, etc., such that the virtual screen continues to directly correspond with the display region and the circumferential span region of the virtual screen. For example, subsequent to reconfiguration of an apparatus, the apparatus may identify a longitudinal edge and an opposite longitudinal edge of the flexible display based, at least in part, on the determination that the flexible display has been reconfigured such that the flexible display is in a partial cylindrical configuration. In such an example, the apparatus may determine a circumferential span from the longitudinal edge to the opposite longitudinal edge, and determine a circumferential span region of a virtual screen based, at least in part, on the circumferential span. In such an example, the apparatus may resize the virtual screen based, at least in part, on the circumferential span region.

FIG. 5B is a diagram illustrating a virtual screen and an apparatus according to at least one example embodiment. The example of FIG. 5B depicts virtual screen 520, which comprises display region 522A, display region 522B, and circumferential span region 524. The example of FIG. 5B also depicts apparatus 532, which comprises display 534. As can be seen, display 534 is a flexible display that is flexed in a partial cylindrical configuration around a wrist of a user of apparatus 532. As can be seen, display region 522A comprises icon 426A, and display region 522B comprises icon 528A, which correspond with icon 526B and icon 528B, respectively, as displayed on display 534 of apparatus 532. In the example of FIG. 5B, icon 526A is positioned in a row of icons at the top of display region 522A, and icon 528A is positioned in a row of icons within display region 522B.

In the example of FIG. 5B, circumferential span region 524 corresponds with circumferential span 536. For example, circumferential span region 524 may be proportional to circumferential span 536, may be based, at least in part, on circumferential span 536, and/or the like. As can be seen in the example of FIG. 5B, circumferential span region 524 is between display region 522A and display region 522B of virtual display 520. In this manner, the content of virtual screen 520 has been wrapped such that the content of virtual screen 520 spans across circumferential span region 524. As a user scrolls circularly scrolls through the content comprised by virtual screen 520 by way of apparatus 532 and display 534, the content cyclically revolves around flexible display 534. In this manner, the user may continuously spin the virtual screen around flexible display 534, such that the entirety of virtual screen 520 either corresponds with the combination of display region 522A, display region 522B, and circumferential span region 524.

The example of FIG. 5B depicts the example of FIG. 5A subsequent to reconfiguration of apparatus 512 of FIG. 5A to the partial cylindrical configuration of apparatus 532, depicted in the example of FIG. 5B. As can be seen, the user has reconfigured the apparatus from a flat configuration to a partial cylindrical configuration. As a result, virtual screen 500 of FIG. 5A has been resized to include circumferential span region 524 of FIG. 5B. As a result, and as can be seen in the examples of FIG. 5A and FIG. 5B, virtual screen 500 of FIG. 5A has been resized to the size depicted in the example of FIG. 5B. For example, the spacing between the icons comprised by virtual screen 520 may have been increased, the dimensions of the icons may have been stretched to fill virtual screen 520 subsequent to resizing, and/or the like.

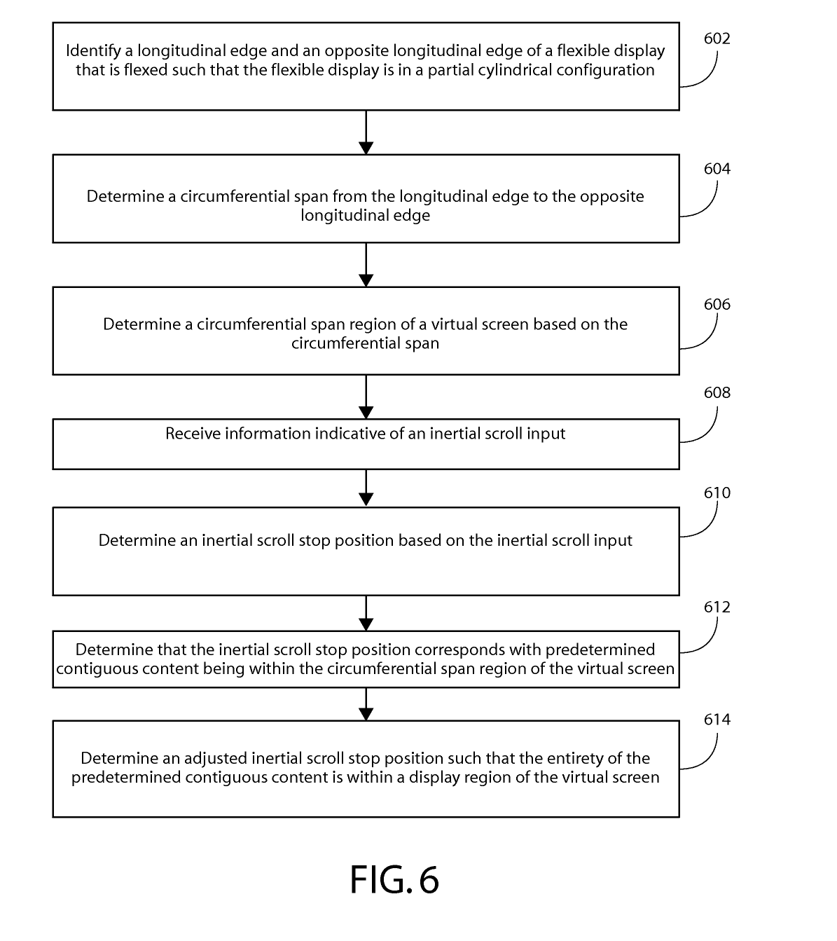

FIG. 6 is a flow diagram illustrating activities associated with determination of an adjusted inertial scroll stop position according to at least one example embodiment. In at least one example embodiment, there is a set of operations that corresponds with the activities of FIG. 6. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 6.

At block 602, the apparatus identifies a longitudinal edge and an opposite longitudinal edge of a flexible display that is flexed such that the flexible display is in a partial cylindrical configuration. The identification, the flexible display, the partial cylindrical configuration, the longitudinal edge, and the opposite longitudinal edge may be similar as described regarding FIGS. 2A-2C, FIG. 3, FIGS. 4A-4D, and FIGS. 5A-5B.

At block 604, the apparatus determines a circumferential span from the longitudinal edge to the opposite longitudinal edge. The determination and the circumferential span may be similar as described regarding FIGS. 2A-2C, FIG. 3, FIGS. 4A-4D, and FIGS. 5A-5B.

At block 606, the apparatus determines a circumferential span region of a virtual screen based, at least in part, on the circumferential span. The determination, the virtual screen, and the circumferential span region of the virtual screen may be similar as described regarding FIGS. 2A-2C, FIGS. 4A-4D, and FIGS. 5A-5B.

At block 608, the apparatus receives information indicative of an inertial scroll input. The receipt and the inertial scroll input may be similar as described regarding FIGS. 2A-2C, FIGS. 4A-4D, and FIGS. 5A-5B.

At block 610, the apparatus determines an inertial scroll stop position based, at least in part, on the inertial scroll input. The determination and the inertial scroll stop position may be similar as described regarding FIGS. 4A-4D and FIGS. 5A-5B.

At block 612, the apparatus determines that the inertial scroll stop position corresponds with, at least a portion of, predetermined contiguous content being within the circumferential span region of the virtual screen. The determination and the predetermined contiguous content may be similar as described regarding may be similar as described regarding FIGS. 4A-4D and FIGS. 5A-5B.

At block 614, the apparatus determines an adjusted inertial scroll stop position such that the entirety of the predetermined contiguous content is within a display region of the virtual screen. The determination, the adjusted inertial scroll stop position, and the display region of the virtual screen may be similar as described regarding FIGS. 2A-2C, FIGS. 4A-4D, and FIGS. 5A-5B.

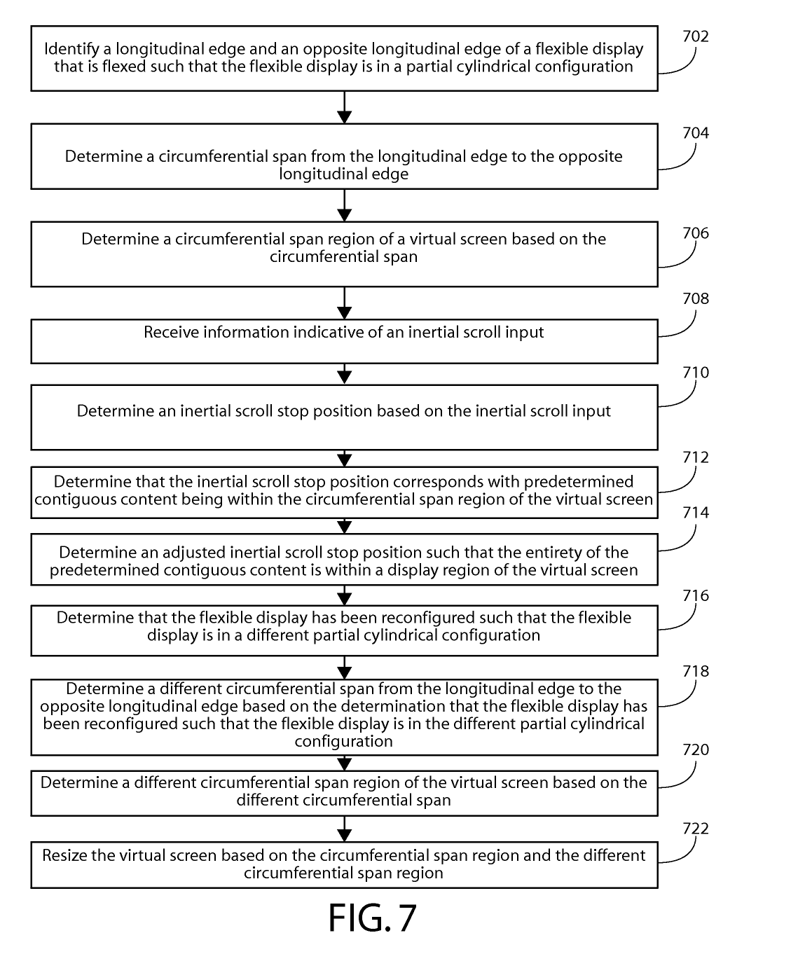

FIG. 7 is a flow diagram illustrating activities associated with resizing of a virtual screen according to at least one example embodiment. In at least one example embodiment, there is a set of operations that corresponds with the activities of FIG. 7. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 7.

As discussed previously, in many circumstances, an apparatus may be configured in a partial cylindrical configuration and subsequently reconfigured in a different partial cylindrical configuration. In such circumstances, it may be desirable to resize a virtual screen associated with the apparatus.

At block 702, the apparatus identifies a longitudinal edge and an opposite longitudinal edge of a flexible display that is flexed such that the flexible display is in a partial cylindrical configuration. The identification, the flexible display, the partial cylindrical configuration, the longitudinal edge, and the opposite longitudinal edge may be similar as described regarding FIGS. 2A-2C, FIG. 3, FIGS. 4A-4D, and FIGS. 5A-5B.

At block 704, the apparatus determines a circumferential span from the longitudinal edge to the opposite longitudinal edge. The determination and the circumferential span may be similar as described regarding FIGS. 2A-2C, FIG. 3, FIGS. 4A-4D, and FIGS. 5A-5B.

At block 706, the apparatus determines a circumferential span region of a virtual screen based, at least in part, on the circumferential span. The determination, the virtual screen, and the circumferential span region of the virtual screen may be similar as described regarding FIGS. 2A-2C, FIGS. 4A-4D, and FIGS. 5A-5B.

At block 708, the apparatus receives information indicative of an inertial scroll input. The receipt and the inertial scroll input may be similar as described regarding FIGS. 2A-2C, FIGS. 4A-4D, and FIGS. 5A-5B.

At block 710, the apparatus determines an inertial scroll stop position based, at least in part, on the inertial scroll input. The determination and the inertial scroll stop position may be similar as described regarding FIGS. 4A-4D and FIGS. 5A-5B.

At block 712, the apparatus determines that the inertial scroll stop position corresponds with, at least a portion of, predetermined contiguous content being within the circumferential span region of the virtual screen. The determination and the predetermined contiguous content may be similar as described regarding may be similar as described regarding FIGS. 4A-4D and FIGS. 5A-5B.

At block 714, the apparatus determines an adjusted inertial scroll stop position such that the entirety of the predetermined contiguous content is within a display region of the virtual screen. The determination, the adjusted inertial scroll stop position, and the display region of the virtual screen may be similar as described regarding FIGS. 2A-2C, FIGS. 4A-4D, and FIGS. 5A-5B.

At block 716, the apparatus determines that the flexible display has been reconfigured such that the flexible display is in a different partial cylindrical configuration. The determination and the different partial cylindrical configuration may be similar as described regarding FIGS. 2A-2C, FIG. 3, FIGS. 4A-4D, and FIGS. 5A-5B.

At block 718, the apparatus determines a different circumferential span from the longitudinal edge to the opposite longitudinal edge based, at least in part, on the determination that the flexible display has been reconfigured such that the flexible display is in the different partial cylindrical configuration. The determination and the different circumferential span may be similar as described regarding FIGS. 2A-2C, FIGS. 4A-4D, and FIGS. 5A-5B.

At block 720, the apparatus determines a different circumferential span region of the virtual screen based, at least in part, on the different circumferential span. The determination and the different circumferential span region may be similar as described regarding FIGS. 2A-2C, FIGS. 4A-4D, and FIGS. 5A-5B.

At block 722, the apparatus resizes the virtual screen based, at least in part, on the circumferential span region and the different circumferential span region. The resizing of the virtual screen may be similar as described regarding FIGS. 4A-4D and FIGS. 5A-5B.

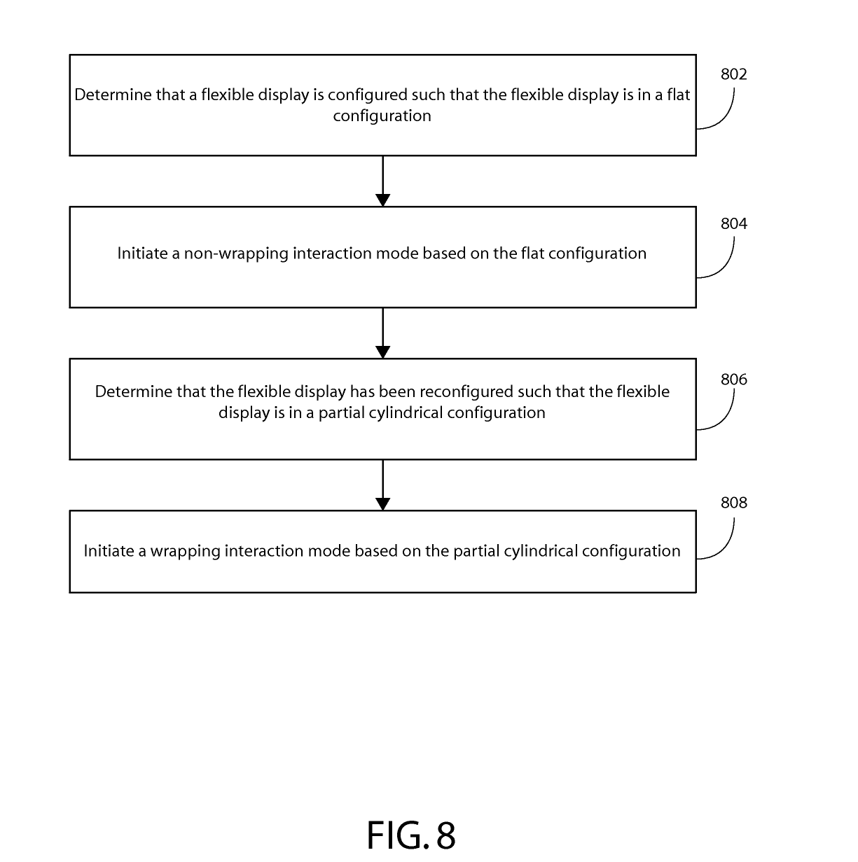

FIG. 8 is a flow diagram illustrating activities associated with initiation of a wrapping interaction mode according to at least one example embodiment. In at least one example embodiment, there is a set of operations that corresponds with the activities of FIG. 8. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 8.

As discussed previously, in many circumstances, an apparatus may be configured in a flat configuration, in a partial cylindrical configuration, and/or the like. In such circumstances, it may be desirable to initiate a non-wrapping interaction mode, a wrapping interaction mode, and/or the like, based, at least in part, on the configuration of the apparatus.

At block 802, the apparatus determines that a flexible display is configured such that the flexible display is in a flat configuration. The determination, the flexible display, and the flat configuration may be similar as described regarding FIGS. 2A-2C, FIGS. 4A-4D, and FIGS. 5A-5B.

At block 804, the apparatus initiates a non-wrapping interaction mode based, at least in part, on the flat configuration. The initiation and the non-wrapping interaction mode may be similar as described regarding FIGS. 4A-4D and FIGS. 5A-5B.

At block 806, the apparatus determines that the flexible display has been reconfigured such that the flexible display is in a partial cylindrical configuration. The determination and the partial cylindrical configuration may be similar as described regarding FIGS. 2A-2C, FIG. 3, FIGS. 4A-4D, and FIGS. 5A-5B.

At block 808, the apparatus initiates a wrapping interaction mode based, at least in part, on the partial cylindrical configuration. The initiation and the wrapping interaction mode may be similar as described regarding FIGS. 2A-2C, FIGS. 4A-4D, and FIGS. 5A-5B.

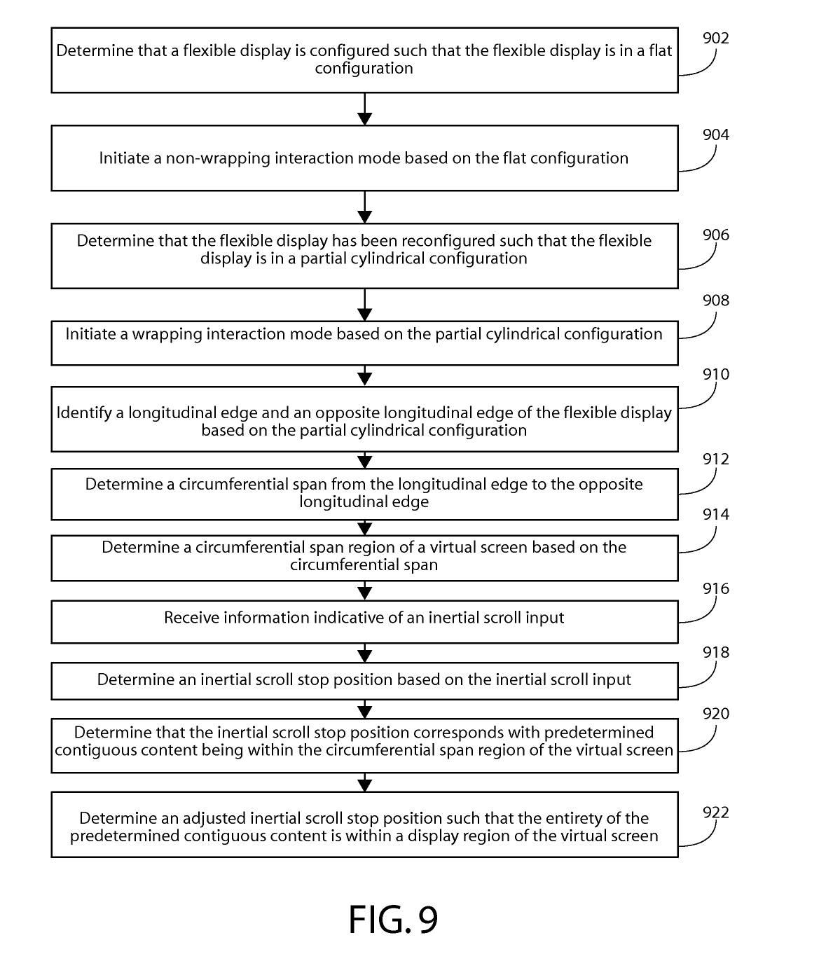

FIG. 9 is a flow diagram illustrating activities associated with determination of an adjusted inertial scroll stop position according to at least one example embodiment. In at least one example embodiment, there is a set of operations that corresponds with the activities of FIG. 9. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 9.

As discussed previously, in many circumstances, it may be desirable to identify a longitudinal edge and an opposite longitudinal edge of a flexible display based, at least in part, on reconfiguration of the flexible display from a flat configuration to a partial cylindrical configuration.

At block 902, the apparatus determines that a flexible display is configured such that the flexible display is in a flat configuration. The determination, the flexible display, and the flat configuration may be similar as described regarding FIGS. 2A-2C, FIGS. 4A-4D, and FIGS. 5A-5B.

At block 904, the apparatus initiates a non-wrapping interaction mode based, at least in part, on the flat configuration. The initiation and the non-wrapping interaction mode may be similar as described regarding FIGS. 4A-4D and FIGS. 5A-5B.

At block 906, the apparatus determines that the flexible display has been reconfigured such that the flexible display is in a partial cylindrical configuration. The determination and the partial cylindrical configuration may be similar as described regarding FIGS. 2A-2C, FIG. 3, FIGS. 4A-4D, and FIGS. 5A-5B.

At block 908, the apparatus initiates a wrapping interaction mode based, at least in part, on the partial cylindrical configuration. The initiation and the wrapping interaction mode may be similar as described regarding FIGS. 2A-2C, FIGS. 4A-4D, and FIGS. 5A-5B.

At block 910, the apparatus identifies a longitudinal edge and an opposite longitudinal edge of the flexible display that is flexed such that the flexible display is in the partial cylindrical configuration. In at least one example embodiment, the identification of the longitudinal edge and the opposite longitudinal edge of the flexible display is based, at least in part, on the determination that the flexible display has been reconfigured such that the flexible display is in the partial cylindrical configuration. The identification, the flexible display, the partial cylindrical configuration, the longitudinal edge, and the opposite longitudinal edge may be similar as described regarding FIGS. 2A-2C, FIG. 3, FIGS. 4A-4D, and FIGS. 5A-5B.

At block 912, the apparatus determines a circumferential span from the longitudinal edge to the opposite longitudinal edge. The determination and the circumferential span may be similar as described regarding FIGS. 2A-2C, FIG. 3, FIGS. 4A-4D, and FIGS. 5A-5B.

At block 914, the apparatus determines a circumferential span region of a virtual screen based, at least in part, on the circumferential span. The determination, the virtual screen, and the circumferential span region of the virtual screen may be similar as described regarding FIGS. 2A-2C, FIGS. 4A-4D, and FIGS. 5A-5B.

At block 916, the apparatus receives information indicative of an inertial scroll input. The receipt and the inertial scroll input may be similar as described regarding FIGS. 2A-2C, FIGS. 4A-4D, and FIGS. 5A-5B.

At block 918, the apparatus determines an inertial scroll stop position based, at least in part, on the inertial scroll input. The determination and the inertial scroll stop position may be similar as described regarding FIGS. 4A-4D and FIGS. 5A-5B.

At block 920, the apparatus determines that the inertial scroll stop position corresponds with, at least a portion of, predetermined contiguous content being within the circumferential span region of the virtual screen. The determination and the predetermined contiguous content may be similar as described regarding may be similar as described regarding FIGS. 4A-4D and FIGS. 5A-5B.

At block 922, the apparatus determines an adjusted inertial scroll stop position such that the entirety of the predetermined contiguous content is within a display region of the virtual screen. The determination, the adjusted inertial scroll stop position, and the display region of the virtual screen may be similar as described regarding FIGS. 2A-2C, FIGS. 4A-4D, and FIGS. 5A-5B.

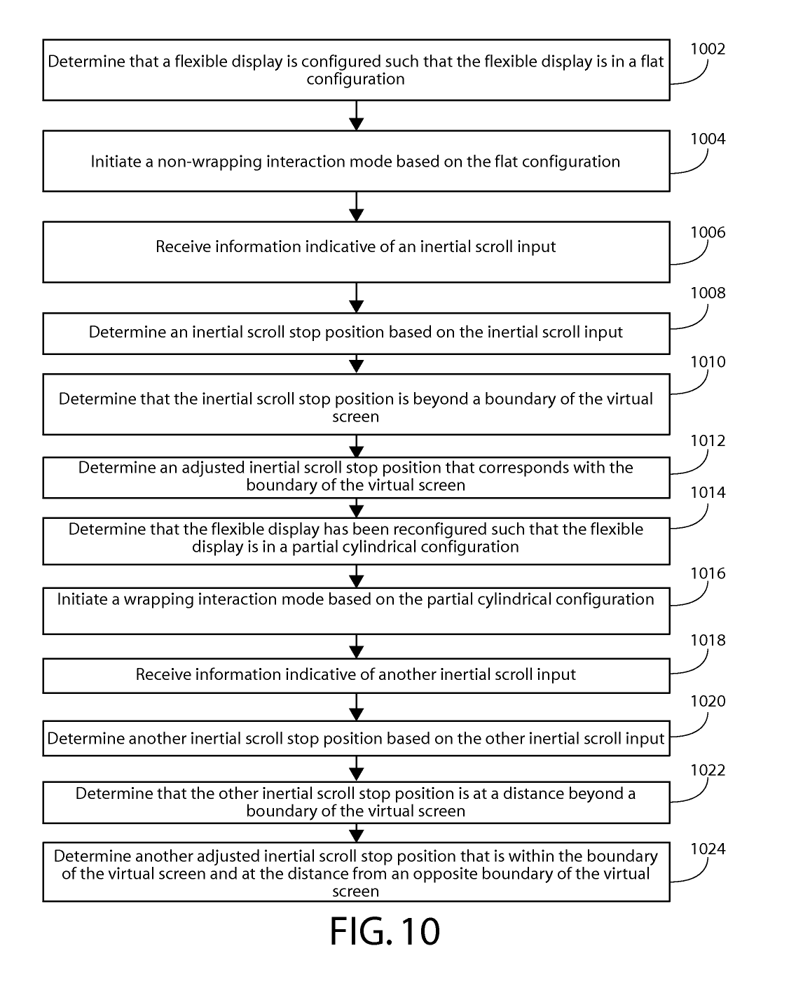

FIG. 10 is a flow diagram illustrating activities associated with determination of an adjusted inertial scroll stop position according to at least one example embodiment. In at least one example embodiment, there is a set of operations that corresponds with the activities of FIG. 10. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 10.

As discussed previously, in many circumstances, it may be desirable to determine an adjusted inertial scroll stop position based, at least in part, on a configuration of an apparatus in a flat configuration, in a partial cylindrical configuration, and/or the like.

At block 1002, the apparatus determines that a flexible display is configured such that the flexible display is in a flat configuration. The determination, the flexible display, and the flat configuration may be similar as described regarding FIGS. 2A-2C, FIGS. 4A-4D, and FIGS. 5A-5B.

At block 1004, the apparatus initiates a non-wrapping interaction mode based, at least in part, on the flat configuration. The initiation and the non-wrapping interaction mode may be similar as described regarding FIGS. 4A-4D and FIGS. 5A-5B.

At block 1006, the apparatus receives information indicative of an inertial scroll input. The receipt and the inertial scroll input may be similar as described regarding FIGS. 2A-2C, FIGS. 4A-4D, and FIGS. 5A-5B.

At block 1008, the apparatus determines an inertial scroll stop position based, at least in part, on the inertial scroll input. The determination and the inertial scroll stop position may be similar as described regarding FIGS. 4A-4D and FIGS. 5A-5B.

At block 1010, the apparatus determines that the inertial scroll stop position is beyond a boundary of the virtual screen. The determination and the boundary of the virtual screen may be similar as described regarding FIGS. 4A-4D and FIGS. 5A-5B.

At block 1012, the apparatus determines an adjusted inertial scroll stop position that corresponds with the boundary of the virtual screen. The determination and the adjusted inertial scroll stop position may be similar as described regarding FIGS. 4A-4D and FIGS. 5A-5B.

At block 1014, the apparatus determines that the flexible display has been reconfigured such that the flexible display is in a partial cylindrical configuration. The determination and the partial cylindrical configuration may be similar as described regarding FIGS. 2A-2C, FIG. 3, FIGS. 4A-4D, and FIGS. 5A-5B.

At block 1016, the apparatus initiates a wrapping interaction mode based, at least in part, on the partial cylindrical configuration. The initiation and the wrapping interaction mode may be similar as described regarding FIGS. 2A-2C, FIGS. 4A-4D, and FIGS. 5A-5B.

At block 1018, the apparatus receives information indicative of another inertial scroll input. The receipt and the other inertial scroll input may be similar as described regarding FIGS. 2A-2C, FIGS. 4A-4D, and FIGS. 5A-5B.

At block 1020, the apparatus determines another inertial scroll stop position based, at least in part, on the other inertial scroll input. The determination and the other inertial scroll stop position may be similar as described regarding FIGS. 4A-4D and FIGS. 5A-5B.

At block 1022, the apparatus determines that the other inertial scroll stop position is at a distance beyond a boundary of the virtual screen. The determination, the distance, and the boundary of the virtual screen may be similar as described regarding FIGS. 4A-4D and FIGS. 5A-5B.

At block 1024, the apparatus determines another adjusted inertial scroll stop position that is within the boundary of the virtual screen and at the distance from an opposite boundary of the virtual screen. The determination, the other adjusted inertial scroll stop position, and the opposite boundary of the virtual screen may be similar as described regarding FIGS. 4A-4D and FIGS. 5A-5B.

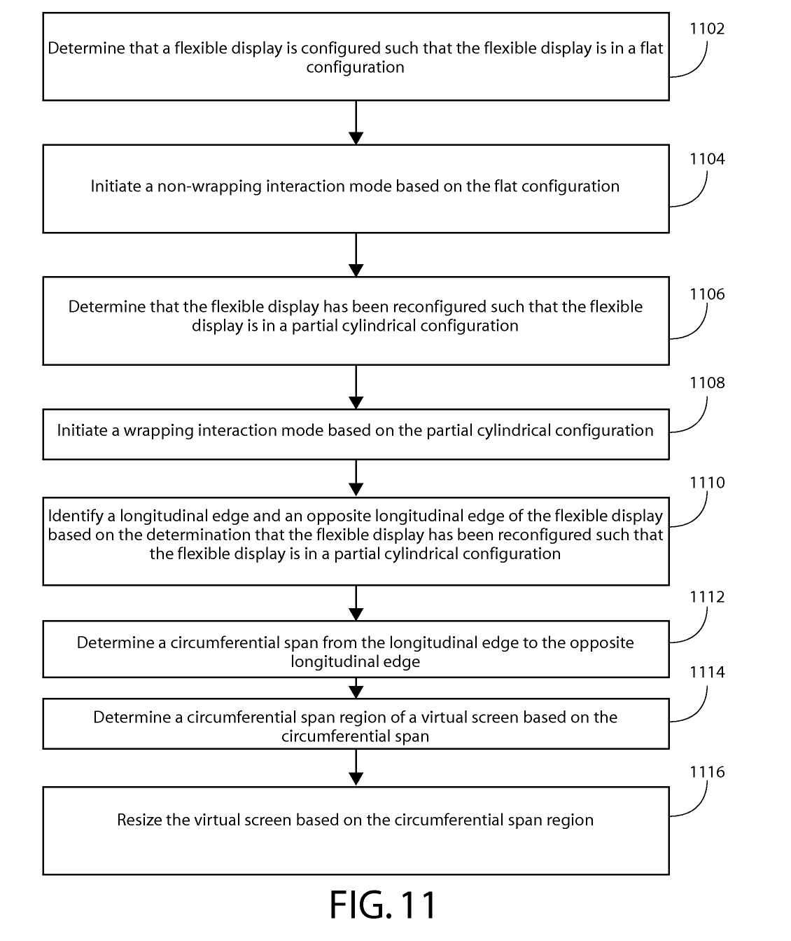

FIG. 11 is a flow diagram illustrating activities associated with resizing of a virtual screen according to at least one example embodiment. In at least one example embodiment, there is a set of operations that corresponds with the activities of FIG. 11. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 11.

As discussed previously, in many circumstances, it may be desirable to configure an apparatus such that the apparatus resizes a virtual screen based, at least in part, on reconfiguration of the apparatus from a flat configuration to a partial cylindrical configuration.

At block 1102, the apparatus determines that a flexible display is configured such that the flexible display is in a flat configuration. The determination, the flexible display, and the flat configuration may be similar as described regarding FIGS. 2A-2C, FIGS. 4A-4D, and FIGS. 5A-5B.

At block 1104, the apparatus initiates a non-wrapping interaction mode based, at least in part, on the flat configuration. The initiation and the non-wrapping interaction mode may be similar as described regarding FIGS. 4A-4D and FIGS. 5A-5B.

At block 1106, the apparatus determines that the flexible display has been reconfigured such that the flexible display is in a partial cylindrical configuration. The determination and the partial cylindrical configuration may be similar as described regarding FIGS. 2A-2C, FIG. 3, FIGS. 4A-4D, and FIGS. 5A-5B.

At block 1108, the apparatus initiates a wrapping interaction mode based, at least in part, on the partial cylindrical configuration. The initiation and the wrapping interaction mode may be similar as described regarding FIGS. 2A-2C, FIGS. 4A-4D, and FIGS. 5A-5B.

At block 1110, the apparatus identifies a longitudinal edge and an opposite longitudinal edge of the flexible display based, at least in part, on the determination that the flexible display has been reconfigured such that the flexible display is in the partial cylindrical configuration. The identification, the longitudinal edge, and the opposite longitudinal edge may be similar as described regarding FIGS. 2A-2C, FIG. 3, FIGS. 4A-4D, and FIGS. 5A-5B.

At block 1112, the apparatus determines a circumferential span from the longitudinal edge to the opposite longitudinal edge. The determination and the circumferential span may be similar as described regarding FIGS. 2A-2C, FIG. 3, FIGS. 4A-4D, and FIGS. 5A-5B.

At block 1114, the apparatus determines a circumferential span region of a virtual screen based, at least in part, on the circumferential span. The determination, the virtual screen, and the circumferential span region of the virtual screen may be similar as described regarding FIGS. 2A-2C, FIGS. 4A-4D, and FIGS. 5A-5B.

At block 1116, the apparatus resizes the virtual screen based, at least in part, on the circumferential span region. The resizing of the virtual screen may be similar as described regarding FIGS. 4A-4D and FIGS. 5A-5B.

Embodiments of the invention may be implemented in software, hardware, application logic or a combination of software, hardware, and application logic. The software, application logic and/or hardware may reside on the apparatus, a separate device, or a plurality of separate devices. If desired, part of the software, application logic and/or hardware may reside on the apparatus, part of the software, application logic and/or hardware may reside on a separate device, and part of the software, application logic and/or hardware may reside on a plurality of separate devices. In an example embodiment, the application logic, software or an instruction set is maintained on any one of various conventional computer-readable media.

If desired, the different functions discussed herein may be performed in a different order and/or concurrently with each other. For example, block 802 and block 804 of FIG. 8 may be performed after block 808 of FIG. 8. Furthermore, if desired, one or more of the above-described functions may be optional or may be combined. For example, block 1018 of FIG. 10 may be optional and/or combined with block 1006 of FIG. 10.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are variations and modifications which may be made without departing from the scope of the present invention as defined in the appended claims.

What is claimed is:

1. An apparatus, comprising:
at least one processor;
at least one memory including computer program code, the memory and the computer program code configured to, working with the processor, cause the apparatus to perform at least the following:
identification of a longitudinal edge and an opposite longitudinal edge of a flexible display that is flexed such that the flexible display is in a partial cylindrical configuration;
determination of a circumferential span from the longitudinal edge to the opposite longitudinal edge;
determination of a circumferential span region of a virtual screen based, at least in part, on the circumferential span;
receipt of information indicative of an inertial scroll input;
determination of an inertial scroll stop position based, at least in part, on the inertial scroll input;
determination that the inertial scroll stop position corresponds with, at least a portion of, predetermined contiguous content being within the circumferential span region of the virtual screen;
determination of an adjusted inertial scroll stop position such that the entirety of the predetermined contiguous content is within a display region of the virtual screen.

2. The apparatus of claim 1, wherein the memory includes computer program code configured to, working with the processor, cause the apparatus to perform causation of display of the display region of the virtual screen on the flexible display.

3. The apparatus of claim 1, wherein the memory includes computer program code configured to, working with the processor, cause the apparatus to perform:
determination of a different circumferential span from the longitudinal edge to the opposite longitudinal edge; and
determination of a different circumferential span region of the virtual screen based, at least in part, on the different circumferential span.

4. The apparatus of claim 3, wherein the memory includes computer program code configured to, working with the processor, cause the apparatus to perform resizing of the virtual screen based, at least in part, on the circumferential span region and the different circumferential span region.

5. The apparatus of claim 1, wherein the virtual screen comprises the display region of the virtual screen and the circumferential span region of the virtual screen.

6. The apparatus of claim 1, wherein the memory includes computer program code configured to, working with the processor, cause the apparatus to perform:
determination that a flexible display is configured such that the flexible display is in a flat configuration;
initiation of a non-wrapping interaction mode based, at least in part, on the flat configuration;
determination that the flexible display has been reconfigured such that the flexible display is in a partial cylindrical configuration; and
initiation of a wrapping interaction mode based, at least in part, on the partial cylindrical configuration.

7. The apparatus of claim 6, wherein the memory includes computer program code configured to, working with the processor, cause the apparatus to perform, in the non-wrapping interaction mode:
receipt of information indicative of an inertial scroll input;
determination of an inertial scroll stop position based, at least in part, on the inertial scroll input;
determination that the inertial scroll stop position is beyond a boundary of the virtual screen; and
determination of an adjusted inertial scroll stop position that corresponds with the boundary of the virtual screen.

8. The apparatus of claim 6, wherein the memory includes computer program code configured to, working with the processor, cause the apparatus to perform, in the wrapping interaction mode:
receipt of information indicative of an inertial scroll input;
determination of an inertial scroll stop position based, at least in part, on the inertial scroll input;
determination that the inertial scroll stop position is at a distance beyond a boundary of the virtual screen; and
determination of an adjusted inertial scroll stop position that is within the boundary of the virtual screen and at the distance from an opposite boundary of the virtual screen.

9. The apparatus of claim 6, wherein the memory includes computer program code configured to, working with the processor, cause the apparatus to perform:
identification of a longitudinal edge and an opposite longitudinal edge of the flexible display based, at least in part, on the determination that the flexible display has been reconfigured such that the flexible display is in a partial cylindrical configuration;
determination of a circumferential span from the longitudinal edge to the opposite longitudinal edge;
determination of a circumferential span region of a virtual screen based, at least in part, on the circumferential span;
resizing of the virtual screen based, at least in part, on the circumferential span region.

10. A method comprising:
identifying a longitudinal edge and an opposite longitudinal edge of a flexible display that is flexed such that the flexible display is in a partial cylindrical configuration;
determining a circumferential span from the longitudinal edge to the opposite longitudinal edge;
determining a circumferential span region of a virtual screen based, at least in part, on the circumferential span;
receiving information indicative of an inertial scroll input;
determining an inertial scroll stop position based, at least in part, on the inertial scroll input;
determining that the inertial scroll stop position corresponds with, at least a portion of, predetermined contiguous content being within the circumferential span region of the virtual screen;
determining an adjusted inertial scroll stop position such that the entirety of the predetermined contiguous content is within a display region of the virtual screen.

11. The method of claim 10, further comprising:
determining a different circumferential span from the longitudinal edge to the opposite longitudinal edge; and
determining a different circumferential span region of the virtual screen based, at least in part, on the different circumferential span.

12. The method of claim 11, further comprising resizing the virtual screen based, at least in part, on the circumferential span region and the different circumferential span region.

13. The method of claim 1, further comprising:
determining that a flexible display is configured such that the flexible display is in a flat configuration;
initiating a non-wrapping interaction mode based, at least in part, on the flat configuration;
determining that the flexible display has been reconfigured such that the flexible display is in a partial cylindrical configuration; and
initiating a wrapping interaction mode based, at least in part, on the partial cylindrical configuration.

14. The method of claim 13, further comprising, in the non-wrapping interaction mode:
receiving information indicative of an inertial scroll input;
determining an inertial scroll stop position based, at least in part, on the inertial scroll input;
determining that the inertial scroll stop position is beyond a boundary of the virtual screen; and
determining an adjusted inertial scroll stop position that corresponds with the boundary of the virtual screen.

15. The method of claim 13, further comprising, in the wrapping interaction mode:
receiving information indicative of an inertial scroll input;
determining an inertial scroll stop position based, at least in part, on the inertial scroll input;
determining that the inertial scroll stop position is at a distance beyond a boundary of the virtual screen; and
determining an adjusted inertial scroll stop position that is within the boundary of the virtual screen and at the distance from an opposite boundary of the virtual screen.

16. The method of claim 13, further comprising:
identifying a longitudinal edge and an opposite longitudinal edge of the flexible display based, at least in part, on the determination that the flexible display has been reconfigured such that the flexible display is in a partial cylindrical configuration;
determining a circumferential span from the longitudinal edge to the opposite longitudinal edge;
determining a circumferential span region of a virtual screen based, at least in part, on the circumferential span;
resizing the virtual screen based, at least in part, on the circumferential span region.

17. At least one computer-readable medium encoded with instructions that, when executed by a processor, perform:
identification of a longitudinal edge and an opposite longitudinal edge of a flexible display that is flexed such that the flexible display is in a partial cylindrical configuration;
determination of a circumferential span from the longitudinal edge to the opposite longitudinal edge;
determination of a circumferential span region of a virtual screen based, at least in part, on the circumferential span;
receipt of information indicative of an inertial scroll input;
determination of an inertial scroll stop position based, at least in part, on the inertial scroll input;
determination that the inertial scroll stop position corresponds with, at least a portion of, predetermined contiguous content being within the circumferential span region of the virtual screen;
determination of an adjusted inertial scroll stop position such that the entirety of the predetermined contiguous content is within a display region of the virtual screen.

18. The medium of claim 1, further encoded with instructions that, when executed by a processor, perform:
determination that a flexible display is configured such that the flexible display is in a flat configuration;
initiation of a non-wrapping interaction mode based, at least in part, on the flat configuration;
determination that the flexible display has been reconfigured such that the flexible display is in a partial cylindrical configuration; and
initiation of a wrapping interaction mode based, at least in part, on the partial cylindrical configuration.

19. The medium of claim 18, further encoded with instructions that, when executed by a processor, perform, in the non-wrapping interaction mode:
receipt of information indicative of an inertial scroll input;
determination of an inertial scroll stop position based, at least in part, on the inertial scroll input;
determination that the inertial scroll stop position is beyond a boundary of the virtual screen; and
determination of an adjusted inertial scroll stop position that corresponds with the boundary of the virtual screen.

20. The medium of claim 18, further encoded with instructions that, when executed by a processor, perform, in the wrapping interaction mode:
receipt of information indicative of an inertial scroll input;
determination of an inertial scroll stop position based, at least in part, on the inertial scroll input;
determination that the inertial scroll stop position is at a distance beyond a boundary of the virtual screen; and
determination of an adjusted inertial scroll stop position that is within the boundary of the virtual screen and at the distance from an opposite boundary of the virtual screen.
